(19) United States
(12) Patent Application Publication
(10) Pub. No.: US 2009/0033983 A1
(43) Pub. Date: Feb. 5, 2009

(54) IMAGE FORMING APPARATUS AND INFORMATION SHARING SYSTEM FOR IMAGE FORMING APPARATUS

(75) Inventors: Kazuyoshi Tanaka, Tokyo (JP); Junichi Isamikawa, Tokyo (JP); Koji Kita, Tokyo (JP)

Correspondence Address: CANTOR COLBURN, LLP, 20 Church Street, 22nd Floor, Hartford, CT, 06103, US

(73) Assignee: Konica Corporation, Tokyo (JP)

(21) Appl. No.: 12/145,386

(22) Filed: Jun. 24, 2008

Related U.S. Application Data
(62) Division of application No. 10/602,140, filed on Jun. 23, 2003.

(30) Foreign Application Priority Data
Jun. 28, 2002 (JP) JP2002-188893
Aug. 15, 2002 (JP) JP2002-236847
Aug. 29, 2002 (JP) JP2002-250489

(51) Int. Cl. G06F 3/12

(52) U.S. Cl. 358/1.15

(57) ABSTRACT

An information sharing system capable of transferring determined data between a plurality of image forming apparatuses each other extremely efficiently and accurately, and an image forming apparatus for the information sharing system. The image forming apparatus has: a storage for storing determined data for controlling image formation; a determined data providing section for performing a processing concerning a predetermined request; a determined data obtaining section for making the predetermined request; and a controller for controlling the determined data providing section and the determined data obtaining section.

### CROSS REFERENCE TO RELATED APPLICATIONS

The present application is a divisional application of U.S. patent application Ser. No. 10/602,140 filed Jun. 23, 2003, the entire contents of which are incorporated herein by reference and priority to which is claimed herein. The 10/602,140 application claimed benefit of the date of the earlier filed Japanese Patent Applications No. 2002-188893 filed Jun. 28, 2002, No. 2002-236847 filed Aug. 15, 2002, and No. 2002-250489 filed Aug. 29, 2002, all of which are incorporated herein by reference, and priority of all of which is claimed herein.

### BACKGROUND OF THE INVENTION

1. Field of the Invention

The present invention relates to an image forming apparatus and an information sharing system for the image forming apparatus, and in particular to an image forming apparatus comprising a network communication function and an information sharing system for sharing information of the image forming apparatus.

2. Description of Related Art

Various types of determined data such as an ID number related to a method for using an apparatus, a type number of the apparatus, a number of manufacture of the apparatus or the like, a password of a manager of the apparatus, a mail address provide for the apparatus or the like are stored in a nonvolatile memory of the apparatus (image forming apparatus) for inputting and outputting predetermined information such as a printer, a copying machine, a facsimile or the like.

According to an earlier development, in order to confirm or change the determined data, the image forming apparatus applies, for example, a following system. According to the system, a HTTP server for receiving an access through the HTTP (Hyper Text Transfer Protocol) is provided at an inside of the image forming apparatus. Further, a PC (personal computer) is connected to the image forming apparatus through a network cable. Then, when the PC accesses the HTTP server of the image forming apparatus, a browser of the PC refers desired determined data of the image forming apparatus. Therefore, the determined data are changed by a keyboard of the PC as necessary.

Further, in order to transfer determined data stored in a first image forming apparatus to a second image forming apparatus, a following process is used. According to the process, when determined data stored in the first image forming apparatus are outputted to the PC according to the above-described system, the PC is connected to the second image forming apparatus. Therefore, the determined data stored in the first image forming apparatus are outputted to the second image forming apparatus from the PC.

However, according to the above-described process for transferring determined data through the PC, it is impossible that the first image forming apparatus is connected to the second image forming apparatus through a network cable and transfers determined data to the second image forming apparatus directly. Therefore, because it is required to prepare the PC having the browser or the keyboard, and to connect the PC to each image forming apparatus, that takes a lot of time.

On the other hand, instead of applying the above-described process for transferring determined data through the PC, a transfer exclusive program capable of transferring determined data between image forming apparatuses directly may be applied.

However, because there is a case that a protocol capable of being by each image forming apparatus differs for every image forming apparatus, it is required to prepare a complicated program capable of changing the protocol between image forming apparatuses when transferring determined data between the image forming apparatuses. Therefore, because it takes a lot of time to prepare the program, and the size of the program becomes large, it is not used practically.

Further, in recent years, the importance of the image forming apparatus such as a digital copying machine, a facsimile, a scanner or the like increases with the office automation. Therefore, a plurality of image forming apparatuses are provided in the office. Some of the image forming apparatuses have Web server functions. Some of the image forming apparatuses having the Web server functions have functions for sending image data to another apparatus through the communication network by using mail addresses which are previously registered therein.

When using the image forming apparatus, it is required to previously determine data for determining functions, values for adjusting the apparatus, data concerning an user or the like. Further, mail addressees which are used frequently or the like are previously stored in the image forming apparatus. Therefore, because it is not required to input the mail addresses when sending image data to another apparatus, it is useful. The method for determining conditions of the image forming apparatus includes a method that a user inputs various determined data such as conditions of various types of functions, a condition of the network, mail addresses, FAX addresses or the like to the image forming apparatus directly, a method for inputting determined data from another device connected to the image forming apparatus through the communication network to the image forming apparatus.

However, in order to set the plurality of image forming apparatuses as described above to the same condition, it is required to input many items of determined data to each of the image forming apparatuses. It is complicated, takes a lot of time and inefficient. Further, because it is required to input determined data to each image forming apparatus by handwork, there occurs a mistake or omission in determined data. As a result, it is required to improve the method for inputting determined data to the image forming apparatus.

### SUMMARY OF THE INVENTION

The present invention is accomplished in order to solve the above-described problems.

An object of the present invention is to provide an information sharing system capable of transferring determined data between a plurality of image forming apparatuses each other extremely efficiently and accurately, and an image forming apparatus for the information sharing system.

In accordance with a first aspect of the present invention, an image forming apparatus comprises: a storage for storing determined data for controlling image formation; a determined data providing section for performing a processing concerning a predetermined request; a determined data obtaining section for making the predetermined request; and a controller for controlling the determined data providing section and the determined data obtaining section.

According to the apparatus of the first aspect of the present invention, when the image forming apparatus comprising the determined data providing section and the determined data obtaining section is connected to another image forming apparatus, the image forming apparatus can make a predetermined request to another image forming apparatus directly. Consequently, it is possible to provide a system capable of directly transferring a parameter between the image forming apparatuses without applying the general transfer system through the PC or generating the complicated transfer exclusive program.

Preferably, the apparatus of the first aspect of the present invention, further comprises an operation selecting section for selecting any one of the determined data providing section and the determined data obtaining section to be operated.

More preferably, the operation selecting section is an operation section comprising at least one of a touch panel, an operation key and a pointing device.

More preferably, the determined data obtaining section performs an operation for transferring the determined data to an external image forming apparatus, and an operation for making the external image forming apparatus transfer determined data stored in the external image forming apparatus, and the operation selecting section selects any one of the operations.

Preferably, in the apparatus of the first aspect of the present invention, the determined data include at least one of data concerning an operation of the apparatus, an apparatus adjustment value of the apparatus, data concerning a user of the apparatus and a registered mail addresses.

Preferably, in the apparatus of the first aspect of the present invention, the determined data obtaining section transfers the determined data from or to an external image forming apparatus.

Preferably, the apparatus of the first aspect of the present invention, further comprises a determined data transfer section for transferring the determined data to a plurality of external image forming apparatuses in order.

Preferably, in the apparatus of the first aspect of the present invention, the storage comprises a nonvolatile memory, and the processing concerning the predetermined request includes a processing for rewriting determined data stored in the nonvolatile memory.

Preferably, in the apparatus of the first aspect of the present invention, the determined data providing section includes a HTTP server program for performing a processing concerning the predetermined request requested by an external HTTP client, and the determined data obtaining section includes a HTTP client program for making the predetermined request to an external HTTP server.

More preferably, the apparatus is realizable of communication with an external data processing apparatus and the external HTTP server according to the HTTP.

When the present image forming apparatus is connected to another image forming apparatus comprising a HTTP server, the image forming apparatus can directly make the predetermined request to another image forming apparatus according to the HTTP client program. Consequently, it is possible to provide the system capable of directly transferring a parameter between the image forming apparatuses without applying the general transfer system through the PC or generating the complicated transfer exclusive program.

In accordance with a second aspect of the present invention, a system comprises a plurality of image forming apparatuses comprising: a storage for storing determined data for controlling image formation; a determined data providing section for performing a processing concerning a predetermined request; a determined data obtaining section for making the predetermined request; and a controller for controlling the determined data providing section and the determined data obtaining section, wherein the plurality of image forming apparatuses are connected to the other through a network cable.

According to the system of the second aspect of the present invention, because the plurality of above-described image forming apparatuses are connected to the other through the network cable, when one image forming apparatus makes a predetermined request to another image forming apparatus through the determined data obtaining section, another image forming apparatus can perform the processing concerning the predetermined request by the determined data providing section.

Consequently, for example, when one image forming apparatus request another image forming apparatus to transfer determined data stored in another image forming apparatus to the one image forming apparatus, another image forming apparatus can transfer the determined data to the one image forming apparatus by request. When one image forming apparatus request another image forming apparatus to receive determined data stored in the one image forming apparatus, another image forming apparatus can receive the determined data by request.

As a result, it is possible to directly transfer determined data between the image forming apparatuses without applying the general transfer system through the PC or generating the complicated transfer exclusive program.

When the determined data providing section of one image forming apparatus includes the HTTP server program and the determined data obtaining section of the one image forming apparatus includes the HTTP client program, in case the PC having the HTTP server is connected to the image forming apparatus, the one image forming apparatus can perform a processing according to the HTTP as the common communication protocol, like the case another image forming apparatus is connected to the one image forming apparatus.

In accordance with a third aspect of the present invention, an information sharing system for image forming apparatuses comprises: a first image forming apparatus comprising: a first storage for storing first determined data for controlling image formation; a determined data providing section for performing a processing concerning a predetermined request; and a first controller for controlling the determined data providing section; and a second image forming apparatus comprising: a second storage for storing second determined data for controlling image formation; a determined data obtaining section for making the predetermined request; and a second controller for controlling the determined data providing section.

Preferably, in the system of the third aspect of the present invention, the determined data obtaining section sends determined data request data for requesting the first determined data to the determined data providing section, and the determined data providing section provides the first determined data requested based on the determined data request data.

More preferably, each of the first determined data, the second determined data and the determined data request data include item identification data for identifying a determined item.

According to the system, because the determined data are managed for every determined data, a plurality of image forming apparatuses can share the determined data for every determined item.

More preferably, in the above-described system, the second storage comprises a storage area corresponding to the item identification data, and the second controller stores the first determined data received from the first image forming apparatus in the second storage when determining that the second storage comprises a storage area corresponding to the item identification data included in the first determined data received from the first image forming apparatus.

According to the system, when the determined data sent from the first image forming apparatus to the second image forming apparatus can be determined in the second image forming apparatus, the determined data are stored in the second image forming apparatus. Consequently, it is possible to prevent the image forming apparatus from storing unnecessary determined data.

More preferably, in the above-described system, the second controller stores the item identification data and a data storage capacity threshold related to the item identification data in the second storage, and stores the first determined data received from the first image forming apparatus in the second storage when determining that data amount of the first determined data received from the first image forming apparatus is not more than the data storage capacity threshold corresponding to the item identification data included in the first determined data.

According to the system, because it is possible to prevent the memory area of the image forming apparatus from being occupied with specific determined data, the image forming apparatus can operate smoothly.

Preferably, in the system of the third aspect of the present invention, the first controller reads the first determined data stored in the first storage, and makes the determined data providing section send the first determined data to the second image forming apparatus, and the second controller stores the first determined data received by the determined data obtaining section from the first image forming apparatus in the second storage.

According to the system, when set a plurality of image forming apparatuses to the same condition, it is possible to save a time to set the image forming apparatuses individually. Further, because it is possible to prevent errors in determination from occurring when setting the image forming apparatuses individually, it is possible to perform the determination of the image forming apparatus exactly.

Preferably, the system of the third aspect of the present invention, further comprises a plurality of first image forming apparatuses and a plurality of second image forming apparatuses, wherein the determined data obtaining section of any one of the plurality of second image forming apparatuses sends the determined data request data for requesting the first determined data of any one of the plurality of first image forming apparatuses, to the any one of the plurality of first image forming apparatuses, and the first controller of the first image forming apparatus which receives the determined data request data reads the first determined data requested based on the determined data request data out of the first storage, and makes the determined data providing section send the first determined data to the second image forming apparatus.

According to the system, a plurality of image forming apparatuses can share the determined data.

Preferably, in the system of the third aspect of the present invention, the first image forming apparatus further comprises a second determined data obtaining section for making a predetermined request, the second image forming apparatus further comprises a second determined data providing section for performing a processing concerning the predetermined request, the first controller controls the second determined data obtaining section to request the second determined data providing section to output the second determined data, and the second controller controls the second determined data providing section to provide the second determined data to the second determined data obtaining section.

More preferably, each of the first determined data and the second determined data include item identification data for identifying a determined item.

More preferably, the first storage comprises a storage area corresponding to the item identification data, and the first controller stores the second determined data received from the second image forming apparatus in the first storage when determining that the first storage comprises a storage area corresponding to the item identification data included in the second determined data received from the second image forming apparatus.

More preferably, the first controller stores the item identification data and a data storage capacity threshold related to the item identification data in the first storage, and stores the second determined data received from the second image forming apparatus in the first storage when determining that data amount of the second determined data received the second image forming apparatus is not more than the data storage capacity threshold corresponding to the item identification data included in the second determined data.

Preferably, the system of the third aspect of the present invention, further comprises a data processing apparatus comprising an instruction sending section for sending a determined data providing instruction to at least the first controller, wherein the first image forming apparatus further comprises an instruction receiving section for receiving the determined data providing instruction sent from the instruction sending section, and the first controller provides the first determined data to the second image forming apparatus on the basis of the determined data providing instruction received by the instruction receiving section.

More preferably, the data processing apparatus further comprises an input receiving section for receiving an input of a determined data providing apparatus capable of receiving the determined data providing instruction, wherein the instruction sending section sends the determined data providing instruction to the determined data providing apparatus received by the input receiving section.

Preferably, in the above-described system, the first image forming apparatus further comprises a determination section for determining the first determined data, the first storage stores the first determined data determined by the determination section, and a determined data transfer address to which the first determined data are transferred, and the determined data providing section provides the first determined data stored in the first storage to the determined data transfer address, on the basis of the determined data providing instruction received by the instruction receiving section.

According to the system, because various types of determined data set to one remote image forming apparatus can be transferred to another image forming apparatus, it is possible to set various determined data to a plurality of image forming apparatuses effectively. When the determined data set to one image forming apparatus are set to another image forming apparatus, because the determined data can be transferred to another image forming apparatus, it is possible to prevent errors in determination from occurring.

More preferably, in the above-described system, the first controller determines whether the second image forming apparatus having the determined data transfer address to which the first determined data are transferred is capable of receiving data or not, and the determined data providing section provide the first determined data to the second image forming apparatus when the first controller determines that the second image forming apparatus is capable of receiving data.

According to the system, the image forming apparatus determines whether another image forming apparatus to which the determined data are transferred is capable of receiving data. When it is determined that another image forming apparatus is capable of receiving data, the determined data are transferred. Consequently, it is possible to transfer the determined data in the only case another image forming apparatus is capable of receiving the determined data when the determined data are transferred.

More preferably, in the above-described system, the first controller communicates with the second image forming apparatus, and determines whether the second image forming apparatus is capable of receiving data or not on the basis of a communication result.

According to the system, the image forming apparatus communicates with another image forming apparatus, and determines whether another image forming apparatus is capable of receiving data or not on the basis of the communication result. Consequently, it is possible to determine whether another image forming apparatus to which the determined data are transferred is capable of receiving data or not exactly.

Preferably, in the above-described system, the first controller selects determined data instructed to be provided from the first determined data stored in the first storage on the basis of the determined data providing instruction received by the instruction receiving section, and the determined data providing section provides the determined data selected by the first controller to the second image forming apparatus.

According to the system, the image forming apparatus selects the determined data instructed to be transferred from the determined data stored in the storage on the basis of the providing instruction sent from the data processing apparatus, and transfers the selected determined data to another image forming apparatus. Consequently, it is possible to transfer only desired determined data instructed to be transferred of the determined data stored in the storage to another image forming apparatus.

Preferably, in the above-described system, the first storage stores a plurality of determined data transfer addresses to which the first determined data are transferred, the first controller selects any one of the plurality of determined data transfer addresses stored in the first storage on the basis of the determined data providing instruction received by the instruction receiving section, and the determined data providing section provides the first determined data to the determined data transfer address selected.

According to the system, the image forming apparatus stores a plurality of addresses of image forming apparatuses to which data are transferred in the storage, selects any one of the plurality of addresses on the basis of the providing instruction sent from the data processing apparatus, and transfers the determined data to the selected address. Consequently, it is possible to transfer the determined data to the only desired address.

Preferably, in the above-described system, the second image forming apparatus further comprises a determined data renewing section for renewing the second determined data stored in the second storage based on the first determined data received by the determined data obtaining section from the first image forming apparatus.

According to the system, the image forming apparatus receives the determined data transferred from another image forming apparatus, and renews the determined data stored in the storage on the basis of the received determined data. Consequently, it is possible to renew the determined data based on the determined data transferred from another image forming apparatus easily.

More preferably, in the above-described system, the second image forming apparatus further comprises a save section for saving the second determined data stored in the second storage when renewing the second determined data stored in the second storage based on the first determined data received by the determined data obtaining section from the first image forming apparatus.

According to the system, the image forming apparatus can save the existing determined data when renewing the determined data stored in the storage based on the determined data received from another image forming apparatus. Consequently, because the determined data can be backed up, even if there occurs an error in determination, it is possible to restore the determined data easily.

More preferably, in the above-described system, the determined data providing section sends data for instructing whether to save the second determined data stored in the second storage in the save section of the second image forming apparatus or not, when providing the first determined data stored in the first storage to the second image forming apparatus on the basis of the determined data providing instruction received by the instruction receiving section.

According to the system, the image forming apparatus sends data for instructing whether to save the existing determined data stored in the storage of another image forming apparatus when transferring the determined data stored in the storage to another image forming apparatus on the basis of the providing instruction sent from the data processing apparatus. Consequently, it is possible to prevent unnecessary backup according to the providing instruction sent from the data processing apparatus.

Preferably, the above-described system further comprises a plurality of first image forming apparatuses comprising determination sections for determining the first determined data, and a plurality of second image forming apparatuses, wherein the data processing apparatus further comprises a specifying section for specifying any first image forming apparatus of the plurality of first image forming apparatuses to provide the first determined data, an item of the first determined data of the first image forming apparatus to be provided, and any second image forming apparatus of the plurality of second image forming apparatuses to which the first determined data corresponding to the item are provided, the instruction sending section sends the determined data providing instruction and information specified by the specifying section to the first controller of the first image forming apparatus specified by the specifying section, the first storage stores the first determined data determined by the determination section, and a determined data transfer address to which the first determined data are transferred, the determined data providing section provide the first determined data stored in the first storage on the determined data transfer address on the basis of the determined data providing instruction received by the instruction receiving section, and the second image forming apparatus further comprises a determined data renewing section for renewing the second determined data stored in the second storage based on the first determined data received by the determined data obtaining section from the first image forming apparatus.

Consequently, because various types of determined data set to one image forming apparatus by the remote data processing apparatus can be transferred to another image forming apparatus, it is possible to set various data to a plurality of image forming apparatuses effectively. Further, when the determined data set to one image forming apparatus are set to another image forming apparatus, because the determined data are transferred, it is possible to prevent errors in determination.

More preferably, in the above-described system, the second image forming apparatus further comprises a save section for saving the second determined data stored in the second storage when receiving the first determined data from the first image forming apparatus.

According to the system, when receiving the determined data from another image forming apparatus, the image forming apparatus can save the existing determined data stored in the storage. Consequently, because the determined data are backed up, even if there occurs an error in determination, it is possible to restore the determined data easily.

Preferably, in the above-described system, the second image forming apparatus an existing data sending section for sending the second determined data store in the second storage to the data processing apparatus when receiving the first determined data from the first image forming apparatus, and the data processing apparatus further comprises a save section for saving the second determined data received from the second image forming apparatus.

According to the system, the image forming apparatus sends the existing determined data stored in the storage to the data processing apparatus when receiving the determined data from another image forming apparatus, and the data processing apparatus saves the determined data received from the image forming apparatus. Consequently, it is possible to prevent the capacity of the storage of the image forming apparatus increasing according to the backup.

Preferably, in the above-described system, the specifying section of the data processing apparatus specifies whether to save the second determined data stored in the second storage of the second image forming apparatus to which the first determined data are provided or not, the instruction sending section of the data processing apparatus sends the determined data providing instruction and information specified by the specifying section to the first image forming apparatus specified by the specifying section, the instruction receiving section of the first image forming apparatus receives the determined data providing instruction from the data processing apparatus, and the determined data providing section of the first image forming apparatus sends data for instructing whether to save the second determined data stored in the second storage of the second image forming apparatus or not when providing the first determined data stored in the first storage to the second image forming apparatus on the basis of the determined data providing instruction received by the instruction receiving section.

According to the system, the data processing apparatus specifies whether to save the existing determined data stored in the storage of another image forming apparatus to which the determined data are transferred or not, and sends data for instructing whether to save the existing determined data stored in the storage of another image forming apparatus to which the determined data are transferred or not, when sending the transfer instruction of the determined data to the image forming apparatus which transfers the determined data. When the image forming apparatus receives the transfer instruction from the data processing apparatus and transfers the determined data stored in the storage to another image forming apparatus on the received instruction, the image forming apparatus sends information for instructing whether to save the existing determined data stored in the storage of another image forming apparatus or not. Consequently, it is possible to prevent unnecessary backup.

Preferably, in the above-described system, the first image forming apparatus further comprises a second determined data obtaining section for making a predetermined request, the second image forming apparatus further comprises a second determined data providing section for performing a processing concerning the predetermined request, the instruction sending section of the data processing apparatus sends the determined data providing instruction to the second controller, the second image forming apparatus further comprises a second instruction receiving section for receiving the determined data providing instruction sent from the instruction sending section, and the second controller provides the second determined data to the first image forming apparatus on the basis of the determined data providing instruction received by the second instruction receiving section.

More preferably, the second image forming apparatus further comprises a second determination section for determining the second determined data, the second storage stores the second determined data determined by the second determination section, and a determined data transfer address to which the second determined data are transferred, and the second determined data providing section provides the second determined data stored in the second storage to the determined data transfer address on the basis of the determined data providing instruction received by the second instruction receiving section.

More preferably, the second controller determines whether the first image forming apparatus to which the second determined data are transferred is capable of receiving data or not, and the second determined data providing section provides the second determined data to the first image forming apparatus when the second controller determines that the first image forming apparatus is capable of receiving data.

More preferably, the second controller communicates with the first image forming apparatus, and determines whether the first image apparatus is capable of receiving data or not on the basis of a communication result.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a schematic block diagram for explaining a structure of an information sharing system 100 according to a first embodiment of the present invention;

FIG. 2 is a flowchart for explaining a control processing of the information sharing system 100 shown in FIG. 1;

FIG. 3 is a view for explaining a state of a screen for a pull operation displayed on a display of a second printer 102 of the information sharing system 100 shown in FIG. 1;

FIG. 4 is a schematic block diagram for explaining a structure of an information sharing system 110 according to another example of the first embodiment of the present invention;

FIG. 5 is a flowchart for explaining a control processing of the information sharing system 110 shown in FIG. 4;

FIG. 6 is a view for explaining a state of a screen of a push operation displayed on a display of a first printer 101 of the information sharing system 110 shown in FIG. 1;

FIG. 7 is a schematic block diagram showing a whole structure of an information sharing system 200 according to a second embodiment of the present invention;

FIG. 8 is a block diagram showing a functional structure of a first printer 201-1 of the information sharing system 200 shown in FIG. 7;

FIG. 9 is a diagram showing a structure of a nonvolatile memory 214a of the first printer 201-1 shown in FIG. 8;

FIG. 10 is a block diagram showing a functional structure of a second printer 202-1 of the information sharing system 200 shown in FIG. 7;

FIG. 11 is a view showing an export screen 240;

FIG. 12 is a view showing a file name specifying screen 245;

FIG. 13 is a view showing an import screen 250;

FIG. 14A is an error screen 255, and FIG. 14B is an import completion screen 257;

FIG. 15 is a flowchart showing a determination reading processing performed by a controller 221 of the second printer 202-1 shown in FIG. 10;

FIG. 16 is a flowchart showing a determination export processing performed by a controller 211 of the first printer 201-1 shown in FIG. 8;

FIG. 17 is a flowchart showing a determination writing processing performed by the controller 221 of the second printer 202-1 shown in FIG. 10;

FIG. 18 is a flowchart showing a determination import processing performed by the controller 211 of the first printer 201-1 shown in FIG. 8;

FIG. 19 is a block diagram conceptually showing a whole structure of an information sharing system 210 according to another example of the second embodiment of the present invention;

FIG. 20 is a block diagram showing a functional structure of a data processing apparatus 203 of the information sharing system 210 shown in FIG. 19;

FIG. 21 is a block diagram showing the functional structure of the first printer 201-1 of the information sharing system 210 shown in FIG. 19;

FIG. 22 is a flowchart showing a determination data transfer processing performed between the data processing apparatus 203, the first printer 201-1 and the second printer 202-1 shown in FIG. 19; and

FIGS. 23A and 23B are views showing examples of a Web A screen 330 displayed on a display 234 of the data processing apparatus 203 in Step S303 shown in FIG. 22.

### PREFERRED EMBODIMENTS OF THE INVENTION

Hereinafter, embodiments of the present invention will be described in detail, with reference to figures.

### First Embodiment

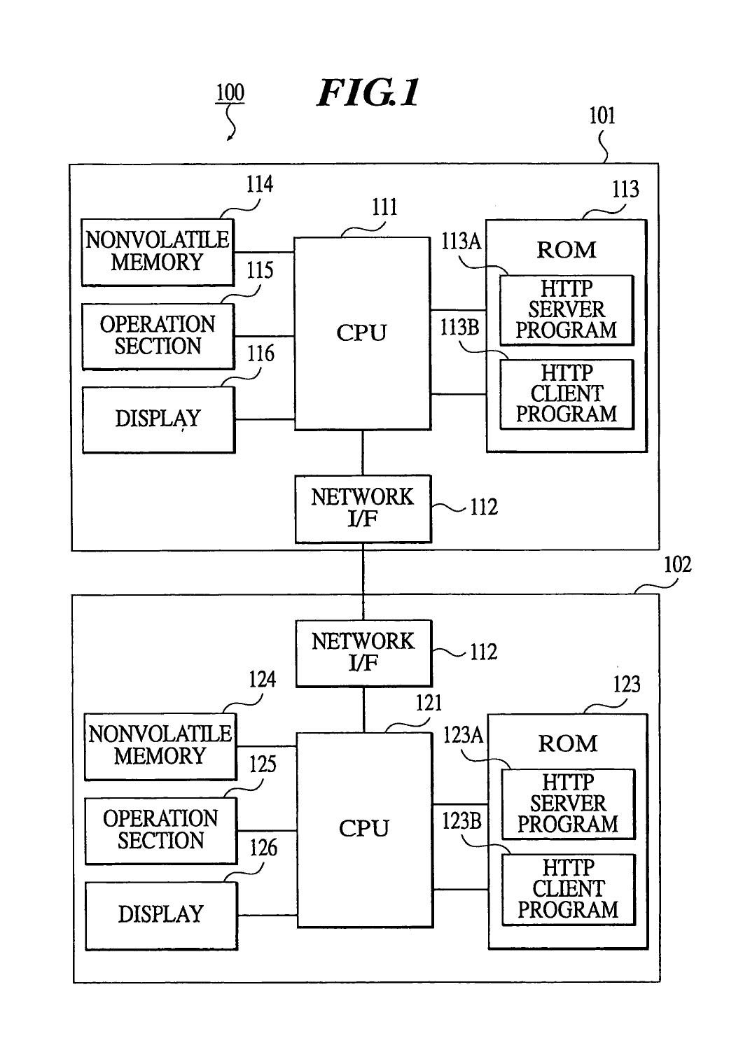

An information sharing system 100 according to the first embodiment will be explained with references to FIGS. 1 to 3. FIG. 1 is a schematic block diagram for explaining the structure of the information sharing system 100 according to the first embodiment.

The information sharing system 100 comprises a first printer 101 including predetermined data, and a second printer 102 connected to the first printer 101 through a network cable C. The first printer 101 and the second printer 102 correspond to the image forming apparatus of the present invention.

The first printer 101 comprises a CPU (Central Processing Unit) 111, a network I/F 112, a ROM (Read Only Memory) 113, a nonvolatile memory 114, an operation section 115 and a display 116, as shown in FIG. 1.

The CPU 111 controls the whole first printer 101 by executing various types of programs stored in the ROM 113 or the nonvolatile memory 114.

The network I/F 112 is an interface so that the first printer 101 communicates with the second printer 102 through the network cable C.

The ROM 113 is a read only memory for storing various types of control programs for controlling the operation of the first printer 101 therein. According to the embodiment, as shown in FIG. 1, a HTTP server program 113A and a HTTP client program 113B are stored in the ROM 113. The communication protocol of the first printer 101 for communication with the second printer 102 or the like is not limited to the HTTP, but may be any protocol so that the first printer 101 can communicate with the second printer 102 or the like.

The HTTP server program 113A is a program realizable of a processing by predetermined request of an external HTTP client. More specifically, the HTTP server program 113A carries out a function of receiving a predetermined request of an external HTTP client, executing a predetermined control program and performing a processing according to the request, when being executed by the CPU 111.

The HTTP client program 113B is a program for making a predetermined request to an external HTTP server. More specifically, the HTTP client program 113b carries out a function of sending a predetermined request inputted through the following operation section 115 to an external HTTP server when being executed by the CPU 111.

The nonvolatile memory 114 stores various types of parameters or control programs for the first printer 101 so as to rewrite them electrically. The nonvolatile memory 114 can apply a PROM (Programmable Read Only Memory) in which a content can be written electrically, an EEPROM which can rewrite a content thereof electrically, a SRAM (Static RAM), a flash memory or the like.

The nonvolatile memory 114 stores various types of determined data including data concerning the operation of the first printer 101, values for adjusting the printer, data concerning a user and registered mail addresses, therein. A type number of the first printer 101 according to the embodiment is “10.1.2.3”.

The operation section 115 is a unit for inputting a predetermined request to the external HTTP server. The operation section 115 corresponds to the operation section of the present invention. The operation section 115 can apply a touch panel, various types of operation keys such as a cursor key, numeric keys or the like, a pointing device such as a mouse, or the like.

The display 116 carries out a function of displaying a predetermined request for the external HTTP server, and realizing an input of the predetermined request through the operation section 115. The display 116 can apply a CRT (Cathode Ray Tube), a LCD (Liquid Crystal Display) or the like.

The second printer 102 comprises a CPU 121, a network I/F 122, a ROM 123, a nonvolatile memory 124, an operation section 125 and a display 126, as shown in FIG. 1. Because the second printer 102 has substantially the same structure as one of the first printer 101 as described above, it is omitted to explain each section.

The nonvolatile memory 124 of the second printer 102 stores various types of data including data concerning the operation of the second printer 102, values for adjusting the printer, data concerning a user and registered mail addresses, therein.

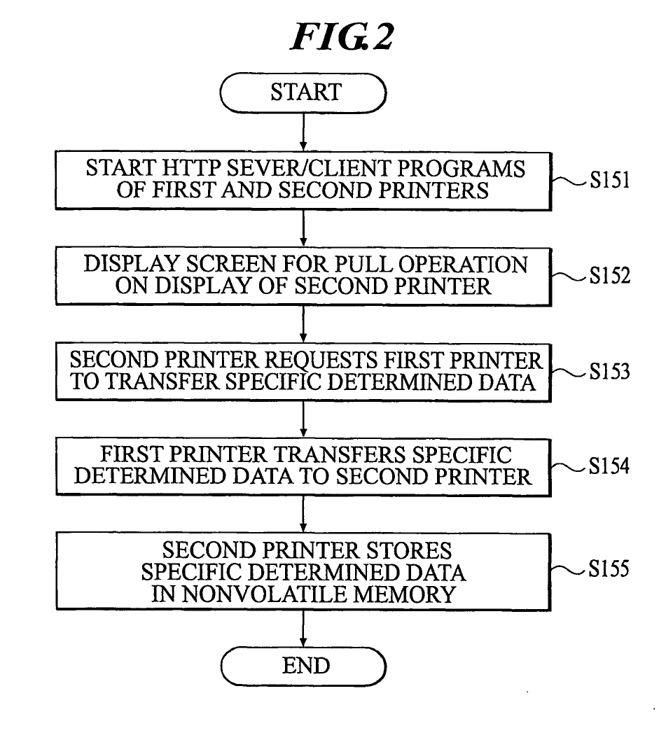

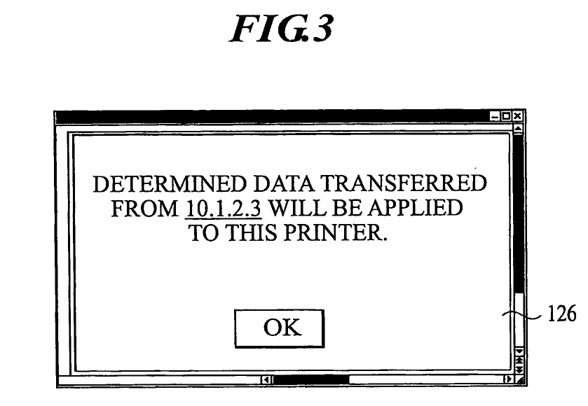

Next, the control processing of the information sharing system 100 according to the first embodiment, will be explained with reference to FIGS. 2 and 3. FIG. 2 is a flowchart for explaining a control processing of the information sharing system 100 according to the embodiment.

First, when the first printer 101 and the second printer 102 are powered on, the HTTP server programs 113A and 123A and the HTTP client programs 113B and 123B of the first and second printers 101 and 102 are started (Step for starting the server/client programs; Step S151).

Next, the information sharing system 100 performs an operation (hereinafter, it will be called “a pull operation”) for transferring specific determined data of determined data stored in the nonvolatile memory 114 of the first printer 101 to the second printer 102, according to the request of the second printer 102. When the pull operation is performed, the second printer 102 functions as a “client”, and the first printer 101 functions as a “server”.

First, when starting a predetermined control program stored in the second printer 102, the second printer 102 displays the screen for the pull operation on the display 126 (Step for displaying the push operation; Step S152). FIG. 3 is a view showing a state of the screen for the pull operation displayed on the display 126. That is, “DETERMINED DATA TRANSFERRED FROM 10.1.2.3 WILL BE APPLIED TO THIS PRINTER.” corresponds to “the screen for the pull operation”. “10.1.2.3” is a type number of the first printer 101.

Then, when the “OK” button of the screen displayed on the display 126 is instructed through the operation section 125, the second printer 102 accesses the first printer 101 through the HTTP client program 123B, the network I/F 122 and the network cable C. Thereafter, the second printer 102 sends the signal (an external determined data transfer request) for requesting to transfer specific determined data to the HTTP server program 113A of the first printer 101 (Step for requesting to transfer determined data; Step S153).

The HTTP server program 113A of the first printer 101 which receives the signal (the external determined data transfer request) for requesting to transfer the specific determined data starts a predetermined control program. Then, the first printer 101 transfers the specific determined data of determined data stored in the nonvolatile memory 114 thereof to the second printer 102 (Step for transferring determined data; Step S154).

When receiving the specific determined data transferred from the first printer 101, the second printer 102 stores the specific determined data in the nonvolatile memory 124, and finishes the pull operation (Step for storing determined data; Step S155).

The second printer 102 which is the image forming apparatus of the present invention comprises the HTTP client program 123B for making a predetermined request to the external HTTP server, and the operation section 125 for inputting the predetermined request. Therefore, the second printer 102 makes the predetermined request (the external determined data transfer request) to the external apparatus comprising the HTTP server through the operation section 125 and the HTTP client program 123B.

Accordingly, as described according to the embodiment, in case the second printer 102 is connected to the first printer 101 which is another image forming apparatus comprising the HTTP server program, the second printer 102 can directly makes the determined request to the first printer 101 by the operation section 125 and the HTTP client program 123B. Consequently, it is possible to provide the information sharing system capable of transferring determined data between printers directly, without applying the general transfer system through the PC or generating a complicated transfer exclusive program.

Further, the information sharing system according to the embodiment is composed of the first printer 101 and the second printer 102 which are connected to each other through the network cable C and each of which comprises the HTTP server program, the HTTP client program and the operation section for inputting the determined request. Therefore, in case a first printer makes a determined request to a second printer through the operation section and the HTTP client program, the second printer can perform the processing based on the determined request according to the HTTP server program.

That is, as described according to the embodiment, when the second printer 102 requests the first printer 101 to transfer specific determined data stored in the first printer 101 to the second printer 102 through the operation section 125 and the HTTP client program 123B, the first printer 101 can transfer the specific determined data to the second printer 102 through the HTTP server program 113A according to the request (external determined data transfer request). Accordingly, it is possible to transfer determined data between printers directly in proper security, without applying a general transfer system through the PC or generating a complicated transfer exclusive program.

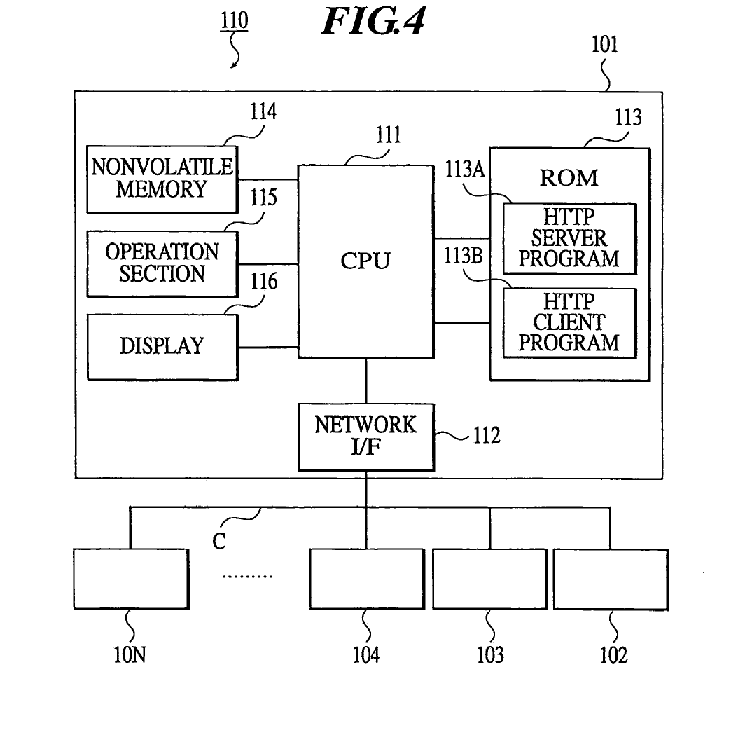

Then, an information sharing system 110 according to another example of the first embodiment of the present invention will be explained with reference to FIGS. 4 to 6. The information sharing system 110 comprises the first printer 101 and a plurality of printers having substantially the same structures as one of the second printer 102, which are connected to the first printer 101. It is omitted to explain the structure of each printer in detail.

FIG. 4 is a schematic block diagram for the structure of the information sharing system 110 according to the embodiment. The information sharing system 110 comprises one first printer 101 including predetermined data, the second printer 102, a third printer 103 and N printer 10N connected to the first printer 101 through the network cable C.

The structures of the second printer 102 to the N printer 10N are not omitted to be shown in figures. According to the embodiment, type numbers of the second printer 102, the third printer 103 and the N printer 10N are determined to be “20.4.5.6”, “30.7.8.9” and “No. 1.2.3”, respectively.

The nonvolatile memory 114 of the first printer 101 stores determined data including data concerning the operation of the first printer 101, values for adjusting the printer, data concerning a user and registered mail addresses, as described above.

Nonvolatile memories of the second printer 102, the third printer 103 and the N printer 10N store determined data including data concerning operations of the printers, values for adjusting the printers, data concerning users and registered mail addresses.

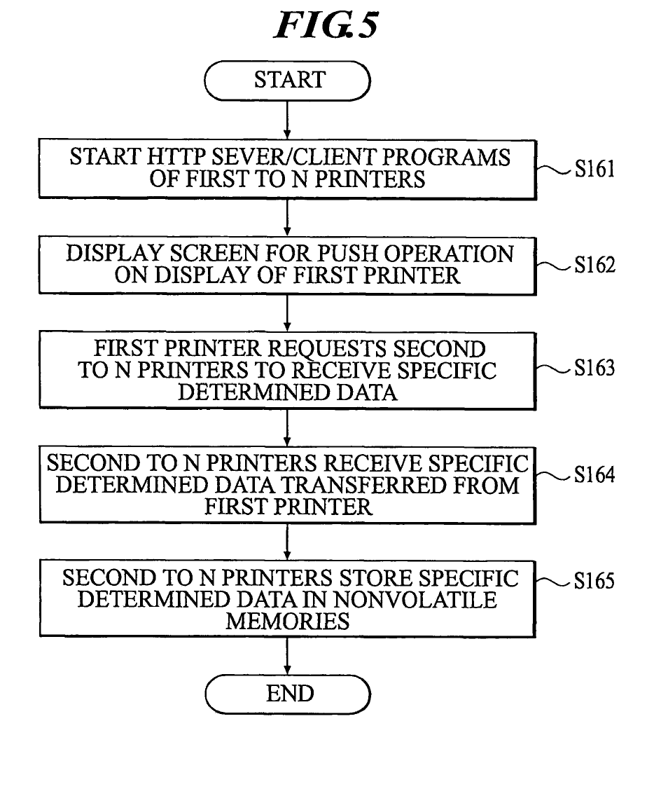

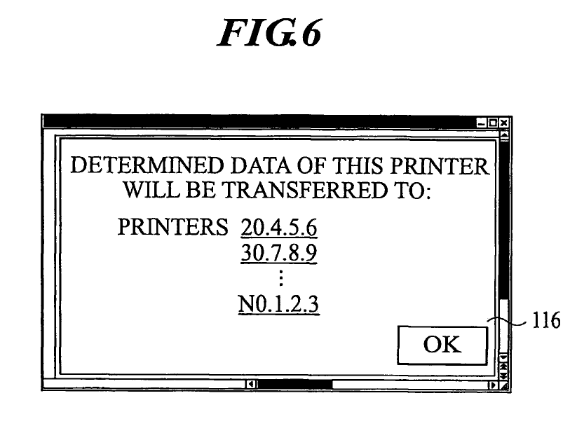

Next, a control processing of the information sharing system 110 according to the embodiment, will be explained with reference to FIGS. 5 and 6. FIG. 5 is a flowchart for explaining the control operation of the information sharing system 110 according to the embodiment.

First, when the first printer 101 to the N printer 10N connected to each other through the network cable C are powered on, the HTTP server programs and the HTTP client programs of the printers are started (Step for starting the server/client programs; Step S161).

Next, the information sharing system 110 performs an operation (hereinafter, it will be called “a push operation”) for transferring specific determined data of determined data stored in the nonvolatile memory 114 of the first printer 101 to the second printer 102 to the N printer 10N, according to the request of the first printer 101. When the push operation is performed, the first printer 101 functions as the “client”, and the second printer 102 to the N printer 10N function as the “server”.

First, in order to perform the push operation, when starting a predetermined control program stored in the first printer 101, the first printer 101 displays the screen for the push operation on the display 116 (Step for displaying the pull operation; Step S162). FIG. 6 is a view showing a state of the screen for the push operation displayed on the display 116. That is, “DETERMINED DATA OF THIS PRINTER WILL BE TRANSFERRED TO; PRINTERS 20.4.5.6, 30.7.8.9, and No. 1.2.3.” corresponds to “the screen for the push operation”. “20.4.5.6” is a type number of the second printer 102, “30.7.8.9” is a type number of the third printer 103, and “No. 1.2.3” is a type number of the N printer 10N.

Then, when the “OK” button of the screen displayed on the display 116 is instructed through the operation section 115, the first printer 101 accesses the second printer 102 to the N printer 10N through the HTTP client program 113B, the network I/F 112 and the network cable C. Thereafter, the first printer 101 sends the signal (an internal determined data receive request) for requesting to receive specific determined data to the HTTP server programs of the second printer 102 to the N printer 10N (Step for requesting to receive determined data; Step S163).

The HTTP server programs of the second printer 102 to the N printer 10N which receive the signal (the internal determined data receive request) for requesting to receive the specific determined data start predetermined control programs. Then, the second printer 102 to the N printer 10N receive the specific determined data transferred from the first printer 101 according to internal determined data transfer programs which are not shown in figures (Step for receiving determined data; Step S164).

When receiving the specific determined data transferred from the first printer 101, the second printer 102 to the N printer 10N store the specific determined data in the nonvolatile memories, and finish the push operation (Step for storing determined data; Step S165).

The first printer 101 which is the image forming apparatus according to the embodiment comprises the HTTP client program 113B for making the predetermined request to the external HTTP server and the operation section 115 for inputting the predetermined request. Therefore, the first printer 101 can make the predetermined request to an external apparatus comprising the HTTP server through the operation section 115 and the HTTP client program 113B.

Accordingly, as described according to the embodiment, when the first printer 101 is connected to the second printer 102 to the N printer 10N which are another image forming apparatuses comprising HTTP server programs, the first printer 101 can make the predetermined request (internal determined data receive request) to the second printer 102 to the N printer 10N directly through the operation section 115 and the HTTP client program 113. Consequently, it is possible to provide the information sharing system capable of transferring determined data between printers directly, without applying the general transfer system through the PC or generating the complicated transfer exclusive program.

Further, the information sharing system 110 according to the embodiment is composed of the first printer 101 to the N printer 10N comprising the HTTP server programs, the HTTP client programs and the operation sections for inputting predetermined requests, which are connected to each other through the network cable C. Therefore, in case one printer makes a predetermined request to another printer by the operation section and the HTTP client program of the one printer, another printer can perform the processing based on the predetermined request according to the HTTP server program.

That is, as described according to the embodiment, when the first printer 101 requests the second printer to the N printer to receive specific determined data stored in the first printer 101 through the operation section 115 and the HTTP client program 113B, the second printer 102 to the N printer 10N can receive the specific determined data through the HTTP server program according to the request (internal determined data receive request). Consequently, it is possible to transfer determined data between printers directly, without applying the general transfer system through the PC or generating the complicated transfer exclusive program.

Further, the information sharing system 110 according to the embodiment can transfer specific determined data stored in one master printer (the first printer 101) to a plurality of printers (the second printer 102 to the N printer 10N). Accordingly, it is unnecessary that a manager goes to and inputs specific determined data (data concerning the operation of the printer, values for adjusting the printer, data concerning a user of the printer and registered mail addresses) to each of the first printer 101 to the N printer 10N.

Further, according to the information sharing system of the above-described embodiment, it is possible to change and realize the pull operation and the push operation easily, by the operation section and the HTTP client program of the first printer 101 or the second printer 102.

According to the first embodiment, the second printer 102 requests the first printer 101 to transfer specific determined data (data concerning the operation of the printer, data for adjusting the printer, data concerning a user of the printer and registered mail addresses), and stores the transferred specific determined data in the nonvolatile memory 124. At the time, the second printer 102 may rewrite an old password or initial set values which are previously stored in the nonvolatile memory 124 before the specific determined data are transferred from the first printer 101.

### Second Embodiment

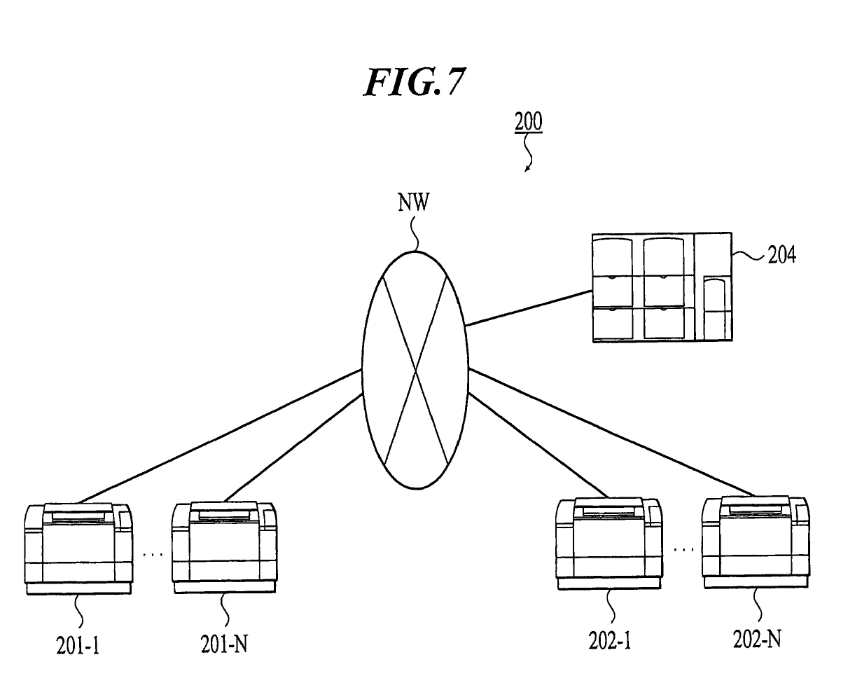

Hereinafter, an information sharing system 200 according to the second embodiment, will be explained in detail, with references to FIGS. 7 to 18.

Herein, determined data according to the second embodiment correspond to the determined data claimed in claims of the present invention, like one of the first embodiment. Identification data according to the second embodiment correspond to the item identification data claimed in claims of the present invention. The determined data include the item identification data for identifying the item of the determined data. The item of the determined data include data concerning the operation of the image forming apparatus, values for adjusting the image forming apparatus, data concerning an user of the image forming apparatus, registered mail addresses and so on.

The information sharing system 200 according to the second embodiment functions as the information sharing system claimed in claims of the present invention. The first printers 201-1 to 201-N function as the first image forming apparatus. The second printers 202-1 to 202-N function as the second image forming apparatus. A controller 211 functions as the first controller and the determined data providing section. A storage 214 functions as the first storage. A controller 221 functions as the second controller and the determined data obtaining section. A storage 224 functions as the second storage. Further, the controller 211 may function as the second determined data obtaining section, and the controller 221 may function as the second determined data providing section.

First, the structure will be explained.

FIG. 7 is a view showing the whole structure of the information sharing system 200 according to the second embodiment. As shown in FIG. 7, the information sharing system 200 comprises first printers 201-1 to 201-N (N is an integer.) and second printers 202-1 to 202-N (N is an integer.) which are connected to each other through a network NW.

FIG. 7 shows an example that the N first printers 201-1 to 201-N and the N second printers 202-1 to 202-N are connected to each other through the network NW. However, the number of printers are not limited specially.

The first printers 201-1 to 201-N are N first image forming apparatuses comprising Web server functions, and have the same structures as each other. Therefore, in order to identify each printer, the terminal names of 201-1 to 201-N are attached to the printers respectively.

The first printers 201-1 to 201-N are connected to the second printers 202-1 to 202-N through the network NW, and operate on the basis of determined data stored therein. Each of the first printers 201-1 to 201-N develops a determined content of the determined data for reading, transferring, changing, writing or the like the determined data on the network NW. When any one of the second printers 202-1 to 202-N accesses the determined content, the corresponding first printer 201 reads determined data required by the second printer 202, and sends it to the second printer 202. Further, when the first printer 201 receives determined data sent from the second printer 202, the first printer 201 stores the determined data therein, or changes determined data stored in the first printer 201 based on the received determined data.

Preferably, the processing of the determined data by using the determined content of the determined data can be performed by only a user in authority or a service man. For example, preferably, when any one of the first printers 201-1 to 201-N identifies an access user on the basis of a password, a user ID or the like, the user can read, transfer, change, write or the like determined data.

Each of the first printers 201-1 to 201-N sends a mail including image data read out of documents placed on each first printer 201 to the printer having the specified mail address through a mail server 204, according to an instruction inputted by the user. Further, each first printer 201 may receive a mail including image data read out of documents placed on the second printer 202 having the specified mail address through the mail server 204, according to the instruction inputted by the user. Each of the first printers 201-1 to 201-N previously registers mail addresses which are used frequently.

The second printers 202-1 to 202-N are N second image forming apparatuses comprising Web server functions, and have the same structures as each other. Therefore, in order to identify each printer, the terminal names of 202-1 to 202-N are attached to the printers respectively.

The second printers 202-1 to 202-N are connected to the first printers 201-1 to 201-N through the network NW, and operate on the basis of determined data stored therein. Each of the second printers 202-1 to 202-N accesses the determined content developed on the network NW by any one of the first printers 201-1 to 201-N in order to change, write, read, transfer or the like the determined data stored in the second printer 201. Then, when the second printer 202 requires determined data of the corresponding first printer 201 and obtains the determines data from the first printer 201, the second printer 202 stores the determined data therein, or changes determined data stored in the second printer 202 on the basis of the obtained determined data. Further, when reading determined data stored therein, the second printer 202 sends the determined data to the corresponding first printer 201.

Preferably, the processing of the determined data by using the determined content of the determined data can be performed by only a user in authority or a service man, like the case of the first printer 201. For example, preferably, when any one of the second printers 202-1 to 202-N identifies an access user on the basis of a password, a user ID or the like, the user can change, write or the like determined data.

Each of the second printers 202-1 to 202-N receives a mail including image data read out of documents placed on the first printer 201 having the specified mail address through the mail server 204, according to the instruction inputted by the user. Further, each second printer 202 may send a mail including image data read out of documents displaced on the second printer 202 to the printer having the specified mail address through the mail server 204, according to the instruction inputted by the user. Each of the second printers 202-1 to 202-N previously registers mail addresses which are used frequently.

The mail server 204 is a computer for sending or receiving electronic mails or controlling accesses of users. The mail server 204 may be connected to the first printers 201-1 to 201-N and the second printers 202-1 to 202-N through the network NW. For example, the mail server 204 receives a mail including image data to be sent to the second printer 202-1 from the first printer 201-1, and sends the mail to the second printer 202-1 when the second printer 202-1 requests the mail. Instead of the mail server 204, a FTP (File Transfer Protocol) server which is connected to the network NW and is not shown in figures can transfer image data from the first printers 201-1 to 201-N to the second printers 202-1 to 202-N.

Next, the internal structure of the first printer 201-1 shown in FIG. 7 will be explained.

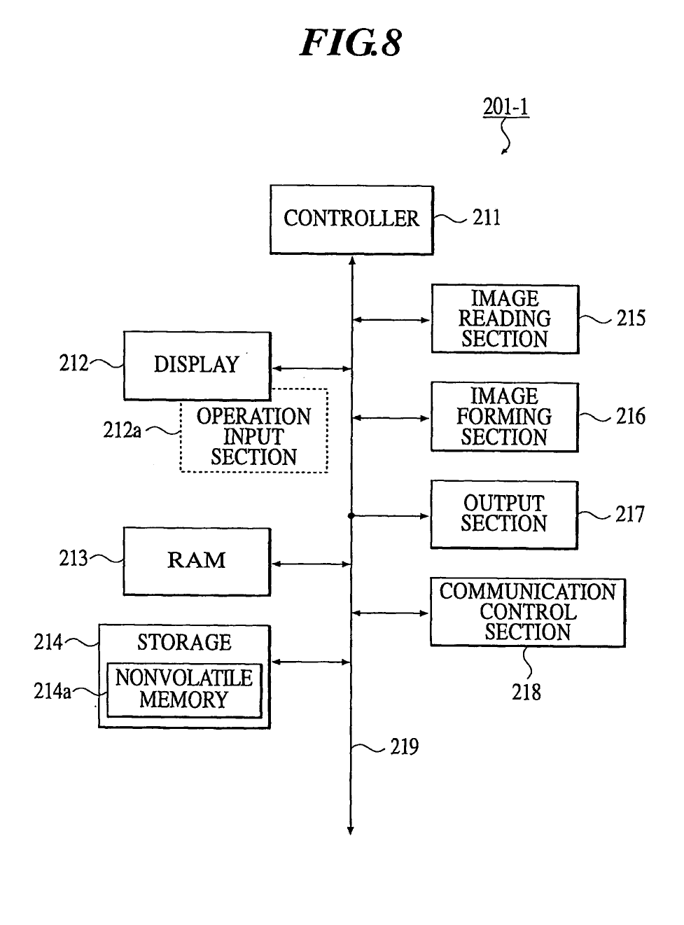

FIG. 8 is a block diagram showing a functional structure of the first printer 201-1. As shown in FIG. 8, the first printer 201-1 comprises the controller 211, a display 212, an operation input section 212a, a RAM 213, the storage 214, an image reading section 215, an image forming section 216, an output section 217 and a communication control section 218, which other than the operation input section 212a are connected to a bus 219 so as to exchange data therebetween.

The controller 211 reads various types of programs stored in the storage 214, develops them in the RAM 213 and controls each section according to the programs in a centralized way. More specifically, the controller 211 reads a determination export processing program or a determination import processing program stored in the storage 214, and performs a determination export processing or a determination import processing as follows, according to instruction data inputted through the operation input section 212 or the communication control section 218. Further, the controller 211 stores results of each processing in the RAM 213, and displays it on the display 212. Then, the controller 211 stores the processing results stored in the RAM 213 in a predetermined area of the storage 214.

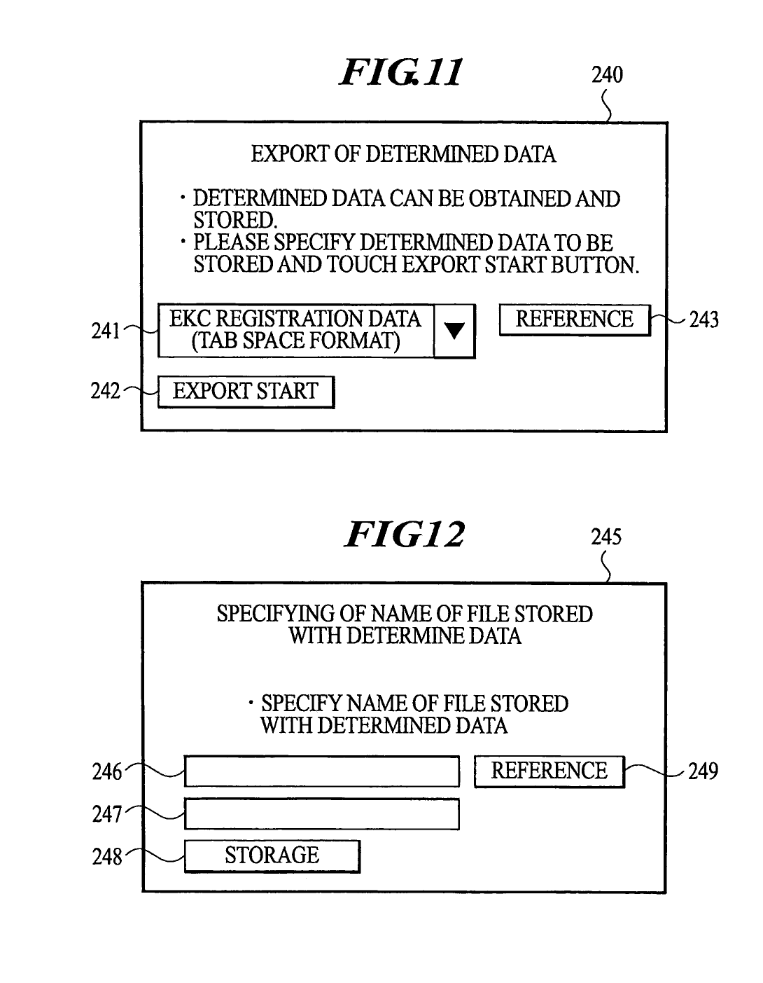

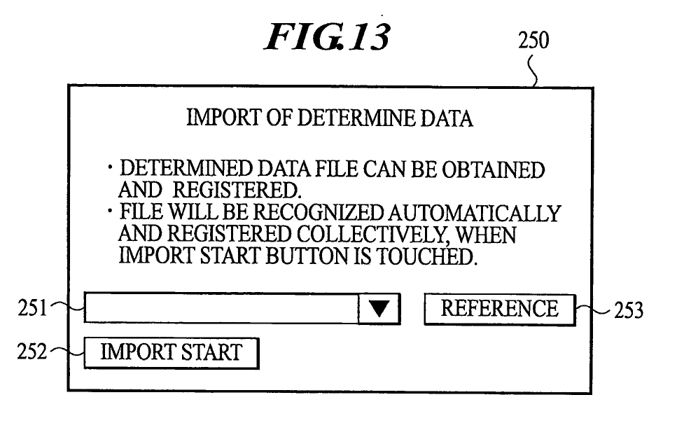

When the controller 211 detects the access of any one of the second printers 202-1 to 202-N, for example, the second printer 202-1 to the determined content according to the signal inputted through the communication control section 218, the controller 211 sends display data for a menu screen which is not shown in figures to the second printer 202-1 and makes the second printer 202-1 display the menu screen thereon. On the menu screen, the second printer 202-1 can request the first printer 201-1 to perform the export processing or the import processing of the determined data. When receiving the request to start the export processing from the second printer 202-1, the controller 211 reads display data for an export processing screen shown in FIG. 11 out of the storage 214, and sends it to the second printer 202-1 through the communication control section 218. On the other hand, when receiving the request to start the import processing from the second printer 202-1, the controller 211 reads display data for an import processing screen shown in FIG. 13 out of the storage 214, and sends it to the second printer 202-1 through the communication control section 218.

According to the determination export processing, when receiving determination data request data from any one of the second printers 202-1 to 202-N, for example, the second printer 202-1, the controller 211 reads requested determined data out of a nonvolatile memory 214a of the storage 214, and sends it to the second printer 201-1 through the communication control section 218.

Herein, the determined data sent from the first printer 201-1 to any one of the second printers 202-1 to 202-N include four types of item identification data for identifying the item of the determined data. Item identification data 1 are data for identifying determined data concerning the operation (for example, an automatic power ON/OFF operation or the like) of the first printer 201-1, item identification data 2 are data for identifying determined data concerning printer adjustment values (for example, reading accuracy determined values when reading images or the like) of the first printer 201-1, item identification data 3 are data for identifying determined data (for example, a user ID, a password or the like) concerning a user (for example, a user of the first printer 201-1, a service man or the like) of the first printer 201-1, and item identification data 4 are data for identifying mail addresses. The amount or item of the item identification data for the determined data is not limited to the above-described one.

According to the determination import processing, when receiving a determination data file and a storage instruction from any one of the second printers 202-1 to 202-N, for example, the second printer 202-1, the controller 211 checks a format of data of the received determined data file.

Herein, the determined data file sent from the second printer 202-1 to the first printer 201-1 is a file for the determined data. The determined data include four types of item identification data for identifying the item of the determined data, like the determined data sent from the first printer 201-1 to any one of the second printers 202-1 to 202-N. Item identification data 1 are data for identifying determined data concerning the operation (for example, an automatic power ON/OFF operation or the like) of the second printer 202-1, item identification data 2 are data for identifying determined data concerning printer adjustment values (for example, reading accuracy determined values when reading images or the like) of the second printer 202-1, item identification data 3 are data for identifying determined data (for example, a user ID, a password or the like) concerning a user (for example, a user of the second printer 202-1, a service man or the like) of the second printer 202-1, and item identification data 4 are data for identifying mail addresses. The amount or item of the item identification data for the determined data is not limited to the above-described one.

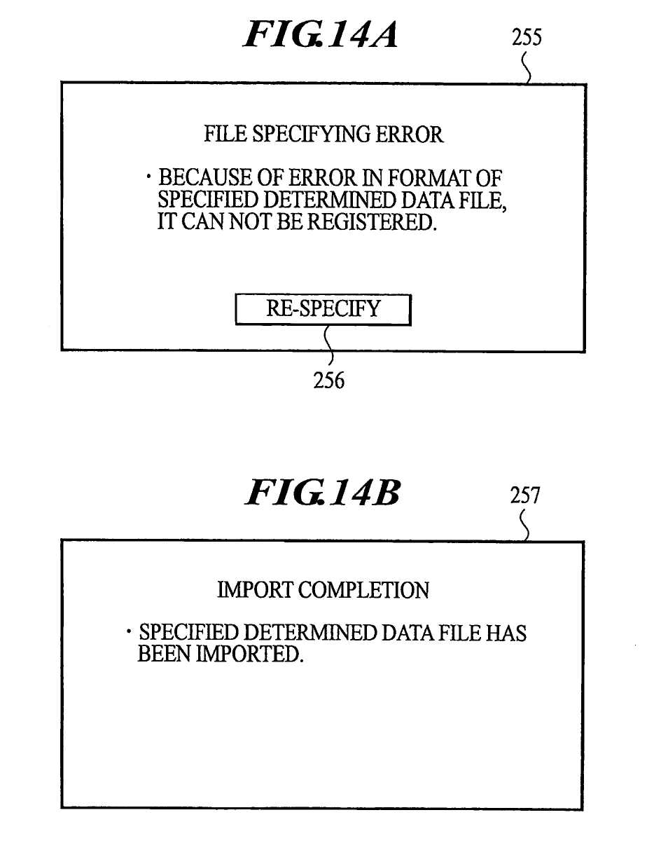

In order to determine the format of the data of the determined data file, the controller 211 determines whether the memory area corresponding to the item identification data of the determined data file received from the second printer 202-1 is prepared in the nonvolatile memory 214a or not. When determining that the memory area corresponding to the received item identification data is prepared in the nonvolatile memory 214a, the controller 211 further determines whether the memory area has some free areas for storing the received determined data therein or not. When determining that the memory area has some free areas, the controller 211 writes the determined data in the free areas. Then, the controller 211 reads display data for the import completion screen (with reference to FIG. 14A) for informing that the instructed determined data is imported completely, out of the storage 214, and sends it to the second printer 202-1 through the communication control section 218.

On the other hand, when determining that the determined data received from the second printer 202-1 can not be written in the nonvolatile memory 214a by determining the format of the data of the determined data file, the controller 211 reads display data for the error screen (with reference to FIG. 14B) for showing that it is finished to write the instructed determined data in the first printer 201-1 because of an error out of the storage 214, and sends it to the second printer 202-1 through the communication control section 218.

The display 212 comprises a LCD (Liquid Crystal Display), an EL (Electro Luminescence) or the like. The display 212 displays display data according to the instruction of the display signal outputted from the controller 211, thereon.

The operation input section 212a is provided as one with the display 212. The operation input section 212a is composed of a pressure sensitive type (resistance film pressure type) of touch panel wherein transparent electrodes are arranged in a grid or preferably, a touch panel having a high permeability of light in view of visibility. When the operation input section 212a detects the voltage value in the positional coordinates of the force point pushed with a finger, an exclusive touch pen or the like, the operation input section 212a outputs the detected positional signal to the controller 211 as the operation signal. Further, the operation input section 212a comprises numeric buttons, function buttons for changing various types of conditions, or the like. The RAM 213 forms a temporary storage area for programs read out of the storage 214, input or output data, parameter or the like, according to various processing performed and controlled by the controller 211.

The storage 214 comprises a storage medium (which is not shown in figures) in which programs, data or the like are previously stored. The storage medium is composed of a magnetic or optical storage medium or a semiconductor memory. The storage medium is fixed at the storage 214 or installed so as to be attached to and detached from the storage 214. The storage medium stores a system program, various types of processing programs corresponding to the system, data processed according to the various types of processing programs or the like, therein. The various types of programs are stored in a readable format of a computer. The controller 211 performs the operation according to the program codes, one by one.

The storage 214 stores, specifically, the determination import processing program, the determination export processing program, image data or application data read by the image reading section 215, display data for the screens shown in FIGS. 11 to 14A, results of various types processing performed by the controller 211 or the like, therein. Further, the storage 214 comprises the nonvolatile memory 214a for storing determined data for the first printer 201-1.

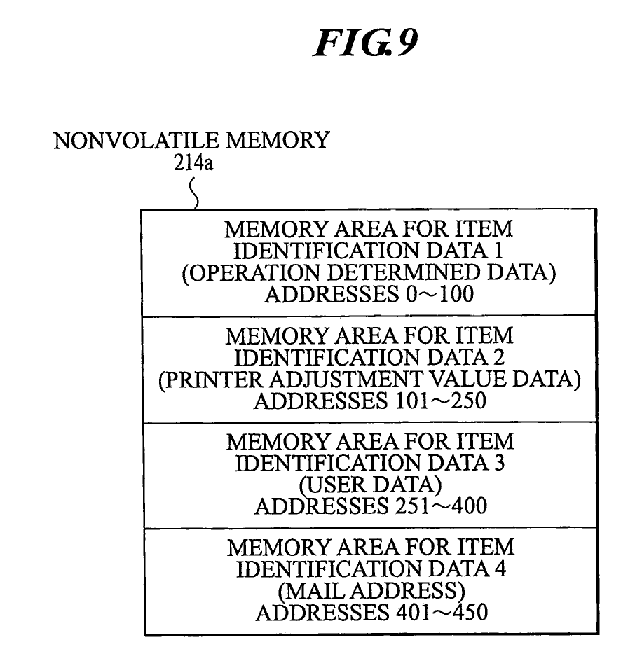

FIG. 9 is a view showing the structure of the nonvolatile memory 214a shown in FIG. 8. As shown in FIG. 9, the nonvolatile memory 214a consists of the memory area for the item identification data 1 for storing the operation determined data, the memory area for the item identification data 2 for the printer adjustment value data, the memory area for the item identification data 3 for storing the user data, and the memory area for the item identification data 4 for storing the mail addresses. The memory areas corresponding to the item identification data 1 to 4 are previously specified according to the instruction inputted by a user in authority or a service man through the operation input section 212a or the communication control section 218.

In the example shown in FIG. 9, the addresses 0 to 100 of the nonvolatile memory 214a are prepared for the memory area of the item identification data 1, the addresses 101 to 250 are prepared for the memory area of the item identification data 2, the addresses 251 to 400 are prepared for the memory area of the item identification data 3, and the addresses 401 to 450 are prepared for the memory area of the item identification data 4. That is, the threshold of the determined data of each item identification data which can be stored in the nonvolatile memory 214a is previously determined based on the addresses prepared for each item identification data.

The controller 211 writes the determined data included in the determined data file received from any one of the second printers 202-1 to 202-N, in the nonvolatile memory 214, when the item identification data included in the determined data file is any one of the item identification data 1 to 4, and the memory area corresponding to the determined data has some free areas for storing the determined data therein.

Herein, the screens stored in the storage 214 will be explained with reference to FIGS. 11 to 14B.

FIG. 11 is a view showing the export screen 240. When receiving the request to perform the export processing from any one of the second printers 202-1 to 202-N, for example, the second printer 202-1, the controller 211 reads the display data for the export screen out of the storage 214, and sends it to the second printer 202-1. As shown in FIG. 11, a determined data specifying area 241, an export start button 242 and a reference button 243 are provided for the export screen 240 displayed on the display 222 of the second printer 202-1. The determined data which are stored so as to be exported in the nonvolatile memory 214a of the first printer 201-1 are displayed in a pull-down format on the determined data specifying area 241. When the reference button 243 is pushed, the directory of the first printer 201-1 is referred, and the determined data of the predetermined directory are displayed on the determined data specifying area 241. When the export start button 242 is pushed after the determined data is specified in the determined data specifying area 241, the second printer 202-1 sends the determined data request data for requesting the specified determined data to the first printer 201-1. The determined data request data include the item identification data of the specified determined data.

FIG. 12 is a view showing the file name specifying screen 245. When the controller 211 reads the determined data requested based on the determined data request data received from the second printer 202-1 out of the nonvolatile memory 214a, the controller 211 sends it and the display data for the file name specifying screen to the second printer 202-1. As shown in FIG. 12, a storage location specifying area 246, a file name input area 247, a storage button 248 and a reference button 249 are provided for the file name specifying screen 245 displayed on the display 222 of the second printer 202-1. When the directory of the second printer 202-1 is referred by pushing the reference button 249, the predetermined storage location is specified in the storage location specifying area 246, the name of the file for storing the determined data is input in the file name input area 247, and the storage button 248 is pushed, the second printer 202-1 stores the determined data received from the first printer 201-1 with the specified file name in the specified directory of the second printer 202-1.

FIG. 13 is a view showing the import screen 250. When receiving the request to perform the import processing from any one of the second printers 202-1 to 202-N, for example, the second printer 202-1, the controller 211 reads the display data for the import screen out of the storage 214, and sends it to the second printer 202-1. As shown in FIG. 13, a file specifying area 251, an import start button 252 and a reference button 253 are provided for the import screen 250 displayed on the second printer 202-1. When the determined data file to be imported on the import screen 250 is referred by pushing the reference button 253, any determined data file is specified in the file specifying area 251, and the import start button 252 is pushed, the second printer 202-1 sends the specified file to the first printer 201-1.

FIG. 14A is a view showing the error screen 255. The controller 211 checks the format of the determined data and the item identification data in the determined data file received from the second printer 202-1. When determining that the memory area corresponding to the received item identification data is not provided in the nonvolatile memory 214a, or the memory capacity for storing the received determined data is short in the nonvolatile memory 214a, the controller 211 reads the display data for the error screen out of the storage 214, and sends it to the second printer 201-1. The message showing that because there is an error in the format of the determined data file, the determined data file can not be imported and a re-specifying button 256 for returning to the import screen are displayed on the error screen 255 displayed on the second printer 202-1.

FIG. 14B is a view showing the import completion screen 257. When the controller 211 writes the determined data in the nonvolatile memory 214a as the result of checking the format of the determined data in the determined data file received from the second printer 202-1, the controller 211 reads the display data for the import completion screen out of the storage 214, and sends it to the second printer 202-1. A message showing that the determined data file has been imported completely is displayed on the import completion screen 257 displayed on the second printer 202-1.

Herein, the functional structure of the first printer 201-1 shown in FIG. 8 will be explained again.

The image reading section 215 comprises a scanner under a contact glass on which documents are placed, and reads image data of the documents by the scanner. The scanner comprises a light source, a lens, a CCD (Charge Coupled Device) or the like. When the light source irradiates light to the document, the reflection of the light is formed and converted electrically. Thereby, when the image of the document is read, the image data of the read image are outputted to the image forming section 216.

The image forming section 216 raster-converts the image data outputted from the image reading section 215, generates a video signal, and thereby forms the image, according to the instruction outputted from the controller 211. Further, the image forming section 216 performs an image processing such as the enlargement, the reduction, the rotation, the change of the position or the like, a gradation processing, a frequency processing or the like to the image data.

The output section 217 comprises a photo-sensitive drum, a toner, a feeder, a paper output unit or the like which is not shown in figures. The output section 217 feeds a printing paper having a size in a direction specified through the operation input section 212a, from the feeder, according to the output instruction of the controller 211. Then, the output section 217 exposes a static latent image of the image data outputted from the image forming section 216 to the recording paper by the photo-sensitive drum. Thereafter, when the output section 217 transcribes the toner to the recording paper to which the static latent image is exposed, and the toner is fixed on the recording paper, the paper is printed and output from the paper output unit.

The communication control section 218 comprises a LAN adapter, a router, a TA (Terminal Adopter) or the like. The communication control section 218 controls communication between apparatuses connected to a LAN or the network N through a communication line such as an exclusive line, the ISDN line or the like.

The structure of the first printer 201-1 has been explained. Because the first printers 201-2 to 201-N have the same structure as one of the first printer 201-1, the structure is not omitted to be explained.

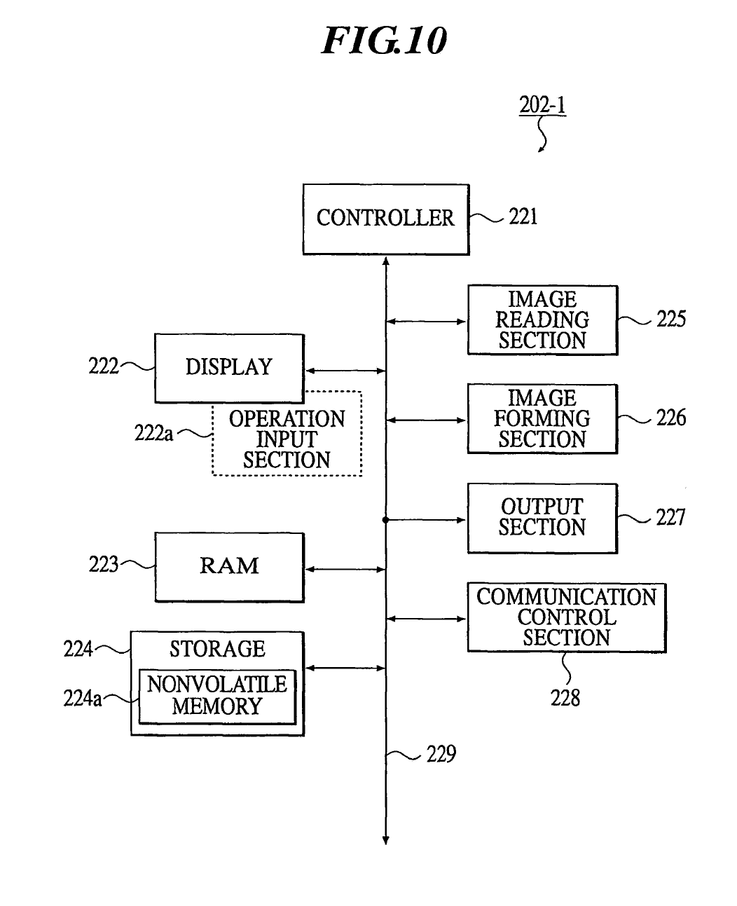

Next, an internal structure of the second printer 202-1 as shown in FIG. 10 will be explained.

FIG. 10 is a block diagram showing the functional structure of the second printer 202-1. As shown in FIG. 10, the second printer 202-1 comprises the controller 221, a display 222, an operation input section 222a, a RAM 223, the storage 224, an image reading section 225, an image forming section 226, an output section 227 and a communication control section 228, which other than the operation input section 222a are connected to each other through a bus 229 so as to exchange data therebetween.

The display 222, the operation input section 222a, the RAM 223, the image reading section 225, the image forming section 226, the output section 227 and the communication control section 228 function like the display 212, the operation input section 212a, the RAM 213, the image reading section 215, the image forming section 216, the output section 217 and the communication control section 218 of FIG. 8, respectively. Therefore, it is omitted to explain the sections.

When the controller 221 reads various types of programs stored in the storage 224 and develops them in the RAM 223, the controller 221 controls each section according to the programs in a centralized way. More specifically, the controller 221 accesses the determined content for the determined data prepared on the network NW by any one of the first printers 201-1 to 201-N according to the instruction inputted through the operation input section 222a. When reading a determination reading processing program and a determination writing processing program stored in the storage 224, the controller 221 performs a determination reading processing and a determination writing processing as follows. Then, the controller 221 stores results of the processing in the RAM 223, and displays them on the display 222. Thereafter, the controller 221 stores the processing results stored in the RAM 223 in a predetermined area of the storage 224.

According to the determination reading processing, when the determined data is specified in the determined data specifying area 241 of the export screen 240 shown in FIG. 11, and the export start button 242 is pushed, the controller 221 sends the determined data request data for requesting the specified determined data to any one of the first printers 201-1 to 201-N, for example, the first printer 201-1, through the communication control section 228. Then, when receiving the display data for the file name specifying screen shown in FIG. 12 from the first printer 201-1, the controller 221 displays the file name specifying screen 245 on the display 222. When the storage location of the determined data is specified on the file name specifying screen 245, the name of the file for storing the determined data is inputted, and the storage button 248 is pushed, the controller 221 stores the determined data received from the first printer 201-1 with the specified file name in the specified storage location.

According to the determination writing processing, when the determined data file is specified and the import start button 252 is pushed on the import screen 250 shown in FIG. 13, the controller 221 sends the specified determined data file and the storage instruction data for instructing to store data of the determined data file to the first printer 201-1 through the communication control section 228. Then, when receiving the display data for the error screen from the first printer 201-1, the controller 211 displays the error screen 255 of FIG. 14A on the display 222. when the re-specifying button 256 is specified on the error screen 255, the controller 221 displays the import screen 250 on the display 222. On the other hand, when receiving the display data for the import completion screen from the first printer 201-1, the controller 221 displays the import completion screen 257 of FIG. 14B on the display 222.

The storage 224 comprises a storage medium (which is not shown in figures) in which programs, data or the like are previously stored. The storage medium is composed of a magnetic or optical storage medium or a semiconductor memory. The storage medium is fixed at the storage 224 or installed so as to be attached to and detached from the storage 214. The storage medium stores a system program, various types of processing programs corresponding to the system, data processed according to the various types of processing programs or the like, therein. The various types of programs are stored in a readable format of a computer. The controller 221 performs the operation according to the program codes, one by one.

The storage 224 stores, specifically, the determination reading processing program, the determination writing processing program, the Web browser software, determined data received from any one of the first printers 201-1 to 201-N according to the determination reading processing performed by the controller 211, results of various types processing performed by the controller 211 or the like, therein.

Next, the operation will be explained.

The determination reading processing performed by the controller 221 of the second printer 202-1, and the export processing performed by the controller 211 of the first printer 201-1 will be explained.

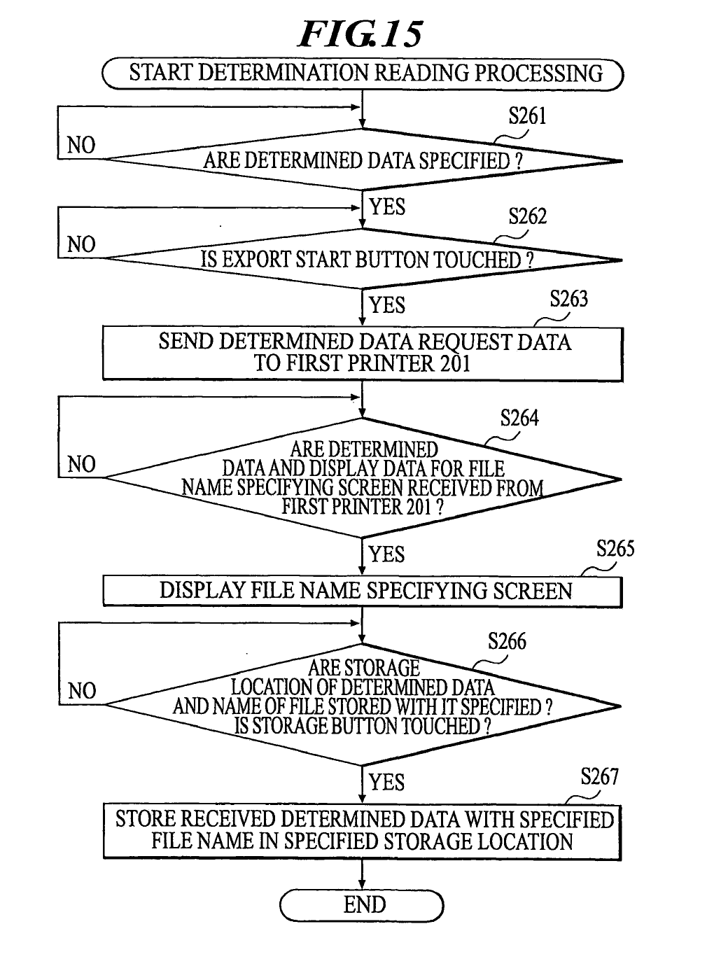

FIG. 15 is a flowchart showing the determination reading processing performed by the controller 221 of the second printer 202-1. As shown in FIG. 15, according to the determination reading processing, the controller 221 determines whether determined data are specified in the determined data specifying area 241 on the export screen 240 of FIG. 11, or not (Step S261). When determined data are not specified (Step S261; NO), the controller 221 keeps waiting. On the other hand, when determined data are specified (Step S261; YES), the controller 22 determines whether the instruction signal of the export start button 242 is inputted through the operation input section 222a or not (Step S262). When the instruction signal of the export start button 242 is inputted (Step S262; YES), the controller 221 sends the determination data request data for requesting the specified determined data to the first printer 201-1 through the communication control section 228 (Step S263). On the other hand, when the instruction signal of the export start button 242 is not inputted (Step S262; NO), the controller 221 keeps waiting.

Then, the controller 221 determines whether the determined data and the display data for the file name specifying screen are received from the first printer 201-1 through the communication control section 228 or not (Step S264). When not receiving them (Step S264; NO), the controller 221 keeps waiting. On the other hand, when receiving them (Step S264; YES), the controller 221 displays the file name specifying screen 245 on the display 222 (Step S265).

Then, the controller 221 determines whether the storage location of the determined data, the data of the file name and the instruction signal of the storage button 248 are inputted through the operation input section 222a or not (Step S266). When not receiving them (Step S266; NO), the controller 221 keeps waiting. On the other hand, when receiving them (Step S266; YES), the controller 221 stores the determined data received from the first printer 201-1 with the specified file name in the specified storage location (Step S267), and finishes the determination reading processing.

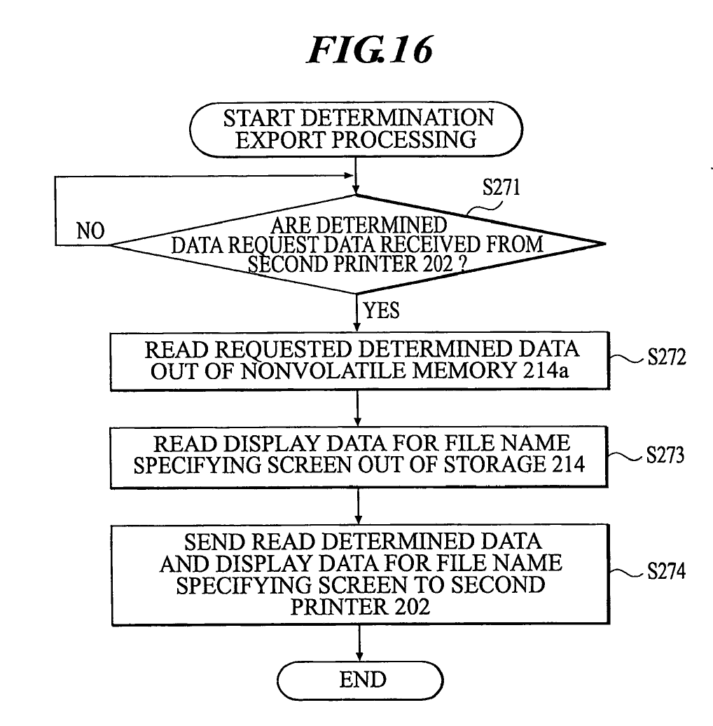

FIG. 16 is a flow chart showing the export processing performed by the controller 211 of the first printer 201-1. As shown in FIG. 16, according to the export processing, the controller 211 determines whether the determined data request data are received from the second printer 202-1 through the communication control section 218 or not (Step S271). When not receiving the determined data request data from the second printer 202-1 (Step S271; NO), the controller 211 keeps waiting.

On the other hand, when receiving the determined data request data from the second printer 202-1 (Step S271; YES), the controller 211 reads the requested determined data out of the nonvolatile memory 214a (Step S272). Then, the controller 221 reads the display data for the file name specifying screen out of the storage 214 (Step S273). Thereafter, the controller 211 sends the determined data and the display data for the file name specifying screen read in Steps S272 and S273 to the second printer 202-1 through the communication control section 218 (Step S274), and finishes the determination export processing.

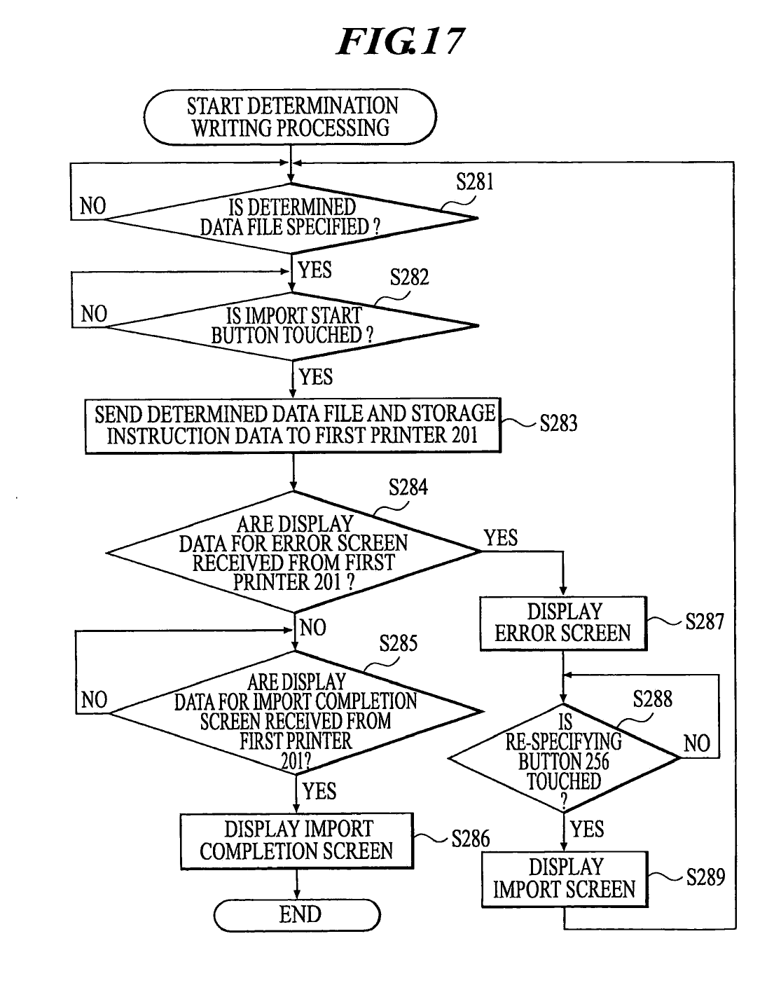

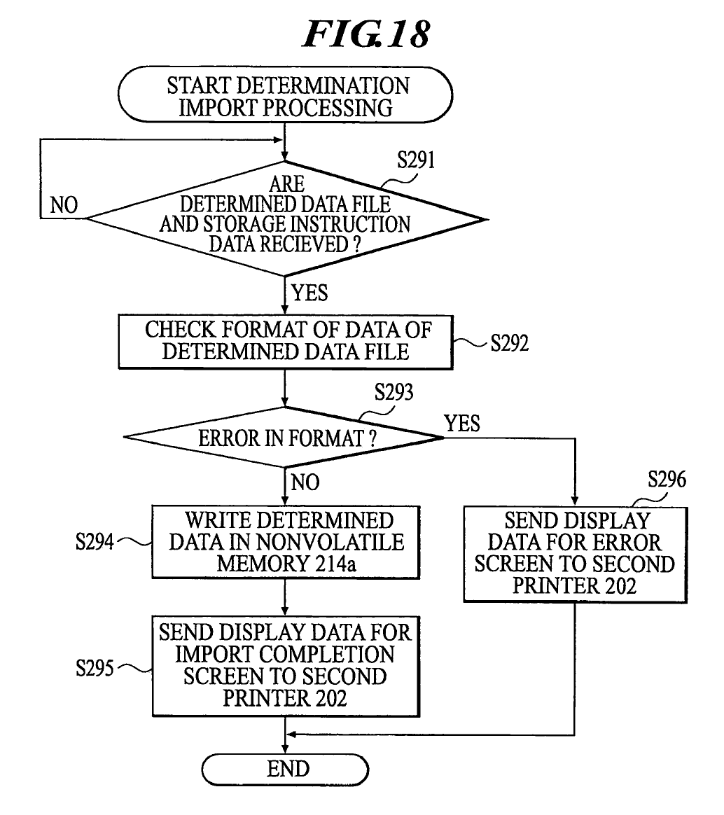

Next, the determination writing processing performed by the controller 221 of the second printer 202-1 and the import processing performed by the controller 211 of the first printer 201-1 will be explained with reference to FIGS. 17 and 18.

FIG. 17 is a flow chart showing the determination writing processing performed by the controller 221 of the second printer 202-1. As shown in FIG. 17, according to the determination writing processing, the controller 221 determines whether the determined data file is inputted in the file specifying area 251 on the import screen shown in FIG. 13 or not (Step S281). When the determined data file is inputted in the file specifying area 251 (Step S281; YES), the controller 281 performs the processing in Step S282. On the other hand, when the determined data file is not inputted in the file specifying area 251 (Step S281; NO), the controller 221 keeps waiting.

In step S282, the controller 221 determines whether the instruction signal of the import start button 252 on the import screen 250 is inputted through the operation input section 222a or not (Step S282). When the instruction signal is not inputted (Step S282; NO), the controller 221 keeps waiting. On the other hand, when the instruction signal is inputted (Step S282; YES), the controller 221 sends the specified determined data file and the storage instruction data to the first printer 201-1 through the communication control section 228 (Step S283).

Then, the controller 221 determines whether the display data for the error screen are received from the first printer 201-1 through the communication control section 228 or not (Step S284). When receiving the display data for the error screen (Step S284; YES), the controller 221 displays the error screen 255 on the display 222 (Step S287). Then, the controller 221 whether the instruction signal of the re-specifying button 256 on the error screen 255 is received or not (Step S288). When the instruction signal is inputted (Step S288; YES), the controller 211 displays the import screen 250 on the display 222 (Step S289), and returns to Step S281. On the other hand, when the instruction signal is not inputted (Step S288; NO), the controller 211 keeps waiting.

When not receiving the display data for the error screen from the first printer 201-1 in Step S284 (Step S284; NO), the controller 211 determines whether the display data for the import completion screen are received from the first printer 201-1 through the communication control section 288 (Step S285). When receiving the display data for the import completion screen (Step S285; YES), the controller 211 displays the import completion screen 257 on the display 222 (Step S286), and finishes the determination writing processing. On the other hand, when not receiving the display data for the import completion screen (Step S285; NO), the controller 211 returns to Step S284.

FIG. 18 is a flow chart showing the determination import processing performed by the controller 211 of the first printer 201-1. As shown in FIG. 18, according to the determination import processing, the controller 211 determines whether the determined data file and the storage instruction data are received from the second printer 202-1 through the communication control section 218 or not (Step S291). When not receiving them (Step S291; NO), the controller 211 keeps waiting. On the other hand, when receiving them (Step S291; YES), the controller 211 checks the format of the data of the determined data file (Step S292), and determines whether there is an error or not (Step S293). When there are not any errors (Step S293; NO), the controller 211 writes the data of the determined data file in the nonvolatile memory 214a (Step S294). Then, when the controller 211 reads the display data for the import completion screen out of the storage 214, the controller 211 sends them to the second printer 202-1 through the communication control section 218 (Step S295), and finishes the determination import processing.

On the other hand, when determining that there is an error in the format of the data of the determined data file received from the second printer 202-1 (Step S293; YES), the controller 211 reads the display data for the error screen out of the storage 214, and sends them to the second printer 202-1 through the communication control section 218 (Step S296). Then, the controller 211 finishes the determination import processing.

Although only the first printer 201-1 and the second printer 202-1 are explained in the above-described explanation of the operation, because the first printer 201-2 to 201-N and the second printer 202-2 to 202-N perform processing like the first printer 201-1 and the second printer 202-1, respectively, it is omitted to explain them.

As described above, in the information sharing system 200, when the first printer 201-1 sends the determined data stored therein to the second printer 202-1, the second printer 202-1 stores the determined data therein. Further, when the first printer 201-1 receives the determined data stored in the second printer 202-1, the first printer 201-1 stores the determined data therein. The first printers 201-2 to 201-N and the second printers 202-2 to 202-N can perform the export processing and the import processing as described above. For example, when the second printer 202-1 obtains the determined data from the first printer 201-1, and transfers them to any one of the first printers 201-2 to 201-N, the first printer 201 can store them therein. Further, when the first printer 201-1 obtains the determined data from the second printer 202-1, and transfers them to any one of the second printers 202-2 to 202-N, the second printer 202 can store them therein.

Accordingly, it is possible to store the same determined data in at least two printers of a plurality of first printers 201-1 to 201-N and second printers 202-1 to 202-N. Further, in order to store the same determined data in the first printers 201-1 to 201-N and the second printers 202-1 to 202-N, it is unnecessary to input the determined data in each printer. Consequently, it is possible to reduce a time or a deal required to input the determined data. Further, because it is unnecessary to input the determined data in the first printers 201-1 to 201-N and the second printers 202-1 to 202-N by handwork, it is possible to prevent the miss in the determination caused by the error input.

Further, because the determined data for every item or all determined data can be stored in a plurality of first printers 201-1 to 201-N and second printers 202-1 to 202N, it is possible to determine the printers so that all the determined data or one of the determined data are the same, as necessary. For example, in case a plurality of printers are further provided in a company or the like, it is possible to read all determined data stored in the existing printer, and store the determined data in the new printers, or store only mail addresses in the new printers. Further, it is possible that a service man determines a plurality of printer adjustment values in order by using any one printer, and inputs the best printer adjustment values in a plurality of printers.

Further, the first printers 201-1 to 201-N and the second printers 202-1 to 202-N do not store data other than those of the predetermined item, and store determined data within the range of the data amount determined for every item of the determined data. Consequently, it is possible to prevent the memory from being occupied with specific determined data. As a result, the printers can operate smoothly.

Further, for example, according to the determination reading processing, the second printer 202-1 can change the determined data obtained from any one of the first printers 201-1 to 201-N, send the changed determined data to the first printers 201-1 to 201-N, and make the printers store them.

The description according to the embodiment is one of preferable examples of the information sharing system 200 of the present invention. The information sharing system 200 is not limited to the above-described embodiment. For example, according to the above-described embodiment, the printer is shown as one example of the image forming apparatus. However, for example, the present invention can be applied to the image forming apparatus such as a facsimile machine, a scanner machine, a combined machine or the like.

Further, various changes and modifications may be made to the detailed structure and operation of each apparatus or each section of the information sharing system 200 without departing from the gist.

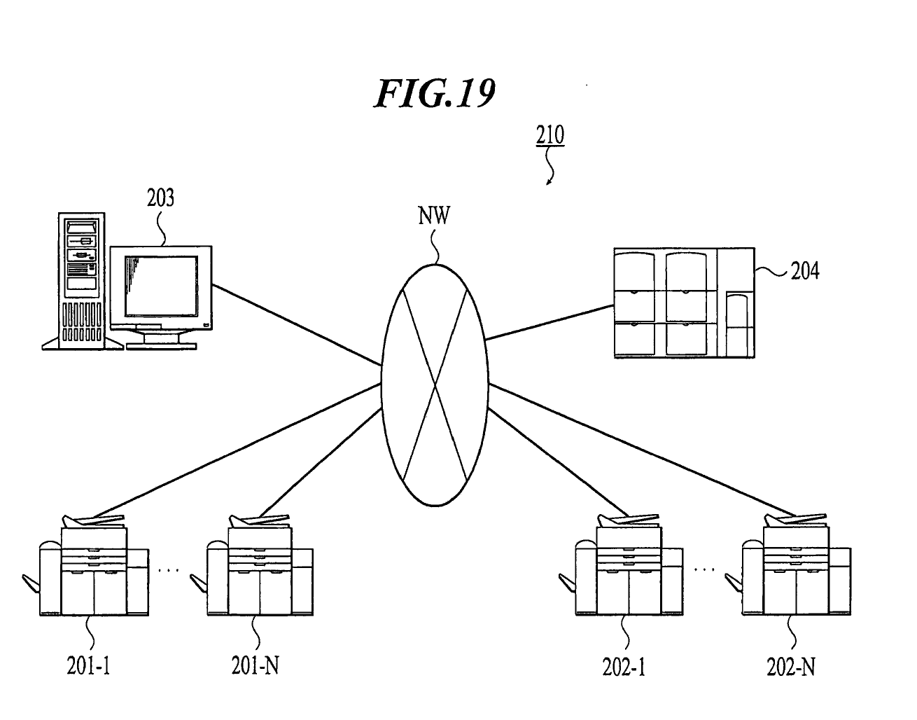

An information sharing system 210 showing an example that the data processing apparatus is applied to the information sharing system 200 according to the second embodiment will be explained with reference to FIGS. 19 to 23B.

First, the structure will be explained as follows.

According to the embodiment, the information sharing system 210 corresponds to the information sharing system comprising the data processing apparatus as claimed in claims of the present invention, a data processing apparatus 203 corresponds to the data processing apparatus, the first printers 201-1 to 201-N correspond to the first image forming apparatus, and the second printers 202-1 to 202-N correspond to the second image forming apparatus.

Further, according to the embodiment, the CPU 211 of the first printer 201-1 further functions as the first controller for determining the state of the second image forming apparatus to which the determined data are transferred from the first image forming apparatus, selecting the determined data to be provided for the second image forming apparatus, or selecting the printer to which the determined data are transferred, as claimed in claims of the present invention. The communication control section 218 further functions as the instruction receiving section of the first image forming apparatus.

Further, the CPU 221 of the second printer 202-1 further functions as the determined data renewing section of the second image forming apparatus or the existing data sending section of the second image forming apparatus by controlling the communication control section 228. The storage 224 further functions as the save section of the second image forming apparatus.

Further, the CPU 231 of the data processing apparatus 203 functions as the instruction sending section for sending the determined data providing instruction and the specified data of the data processing apparatus, by controlling the communication control section 236. The input section 232 function as the specifying section of the data processing apparatus. The storage 235 functions as the save section of the data processing apparatus.

FIG. 19 is a conceptual view showing the whole structure of the information sharing system 210 according to the embodiment. The information sharing system 210 shown in FIG. 19 is a system that the data processing apparatus 203 is further applied to the information sharing system 200. In the information sharing system 210, the data processing apparatus 203, the first printers 201-1 to 201-N and the second printers 202-1 to 202-N are connected through the network NW so as to exchange data therebetween. Like the case of the information sharing system 200 shown in FIG. 7, the number of first printers 201-1 to 201-N of the information sharing system 210 is not limited to two, and any number of first printers may be connected. The number of second printers 202-1 to 202-N is not limited to two, and any number of second printers may be connected. The number of data processing apparatuses 203 is not limited specially.

The data processing apparatus 203 is connected to the network NW, is provided with the NOS (Network Operating System), and functions as the Web server. The data processing apparatus 203 stores information such as the HTML (Hyper Text Markup Language) file, images or the like, on the first printers 201-1 to 201-N and the second printers 202-1 to 202-N. Further, the data processing apparatus 203 is provided with the Web (World Wide Web) browser as a software for reading the stored HTML file. Therefore, the data processing apparatus 203 has a function for displaying information on the first printers 201-1 to 201-N and the second printers 202-1 to 202-N on the Web screen, by specifying the URLs of the first printer 201-1 to 201-N and the second printers 202-1 to 202-N through the Web browser, respectively.

The first printers 201-1 to 201-N and the second printers 202-1 to 202-N exchange various types of data therebetween, on the basis of the instruction data sent from the data processing apparatus 203 through the network NW. The first printers 201-1 to 201-N and the second printers 202-1 to 202-N are provided with exclusive URLs (Uniform Resource Locator) respectively. The data processing apparatus 203 manages Web screens concerning the first printers 201-1 to 201-N and the second printers 202-1 to 202-N.

The line system of the internet NW is shown as a circular system in FIG. 19, but may be determined arbitrarily. The connection between apparatuses may be a wired system or a wireless system, and preferably a network which makes security capable of being accessed by a specific user with in the view of confidence in information management. The internet NW includes, for example, various types of communication networks such as a telephone network, the ISDN network, a private line, a mobile network, a satellite network, a CATV network or the like, and an Internet service provider, a base station or the like for connecting the communication networks. Further, the internet NW includes a relay apparatus such as a router or the like for analyzing exchanged data, determining and transferring the transmission path, and a line gathering apparatus such as a hub or the like comprising a predetermined numbers of ports.

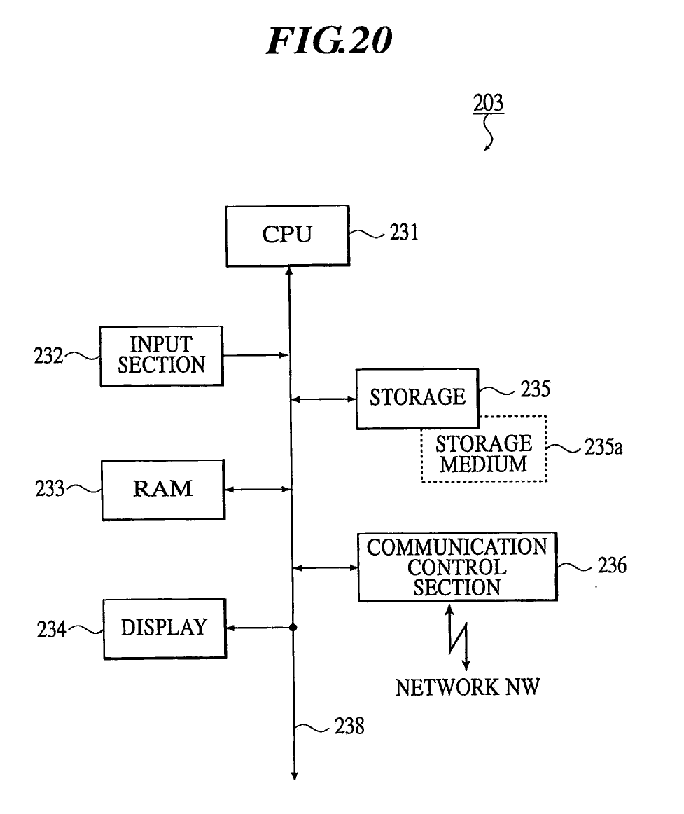

Next, the internal structure of the data processing apparatus 203 will be explained in detail with reference to FIG. 20. FIG. 20 is a block diagram showing the functional structure of the data processing apparatus 203. As shown in FIG. 20, the data processing apparatus 203 comprises a CPU (Central Processing Unit) 231, an input section 232, a RAM (Read Access Memory) 233, a display 234, a storage 235 having a storage medium 235a and a communication control section 236 which other than the storage medium 235a are connected to each other through a bus 238.

The CPU 231 reads a system program or various types of programs stored in the storage 235, and controls the operation of each section according to the system program in a concentrated way. Further, the CPU 231 performs various types of processing according to the read programs.

That is, the CPU 231 performs the following determined data transfer processing according to the read program. That is, when the access signal to the URL of any one of the first printers 201-1 to 201-N and the second printers 202-1 to 202-N registered in the data processing apparatus 203 is inputted through the input section 232, the CPU 231 displays the Web screen corresponding to the access signal by reading the HTML file on the URL. Further, when the determined data and the printer to which the determined data are transferred are specified on the displayed Web screen of any one of the first printers 201-1 to 201-N and the second printers 202-1 to 202-N, the CPU 231 instructs the printer corresponding to the Web screen to transfer the specified determined data to the specified printer. When receiving the request to store backup-data from any printer, the CPU 231 saves the backup-data received from the printer therein.

The input section 232 comprises a keyboard having character/English-language/numeral input keys, cursor keys, various types of function keys and so on, and a mouse as a pointing device. The input section 232 outputs the operation signal of the pushed key of the keyboard or the mouse to the CPU 231 as the input signal.

The RAM 233 is a temporary storage area for storing the executable system program, various types of processing programs, input or output data, parameters or the like, read out of the storage 235 according to various types of processing performed by the CPU 231.

The display 234 comprises a LCD (Liquid Crystal Display), a CRT (Cathode Ray Tube) or the like. The display 234 displays the HTML file of the URL, image data or the like on the screen, according to the instruction based on of the display signal outputted from the CPU 231.

The storage 235 is composed of a HD (Hard Disc), a nonvolatile semiconductor memory or the like, and stores the system program, various types of processing programs capable of being performed according to the system program, data processed according to the programs or the like. The storage 235 comprises the storage medium 235a installed in a removable state. The storage medium 235a is composed of a magnetic or optical storage medium or a nonvolatile memory such as a semiconductor or the like. Because the program is stored in a program code format readable of the computer, the CPU 231 performs the operation according to program codes one by one. According to the embodiment, the storage medium 235a stores information on the HTML (Hyper Text Markup Language) file, images or the like for providing Web screens of the first printers 201-1 to 201-N and the second printers 202-1 to 202-N.

The communication control section 236 controls the communication with the external communication terminal including the first printers 201-1 to 201-N and the second printers 202-1 to 202-N connected to the network NW, on the basis of the Internet protocol.

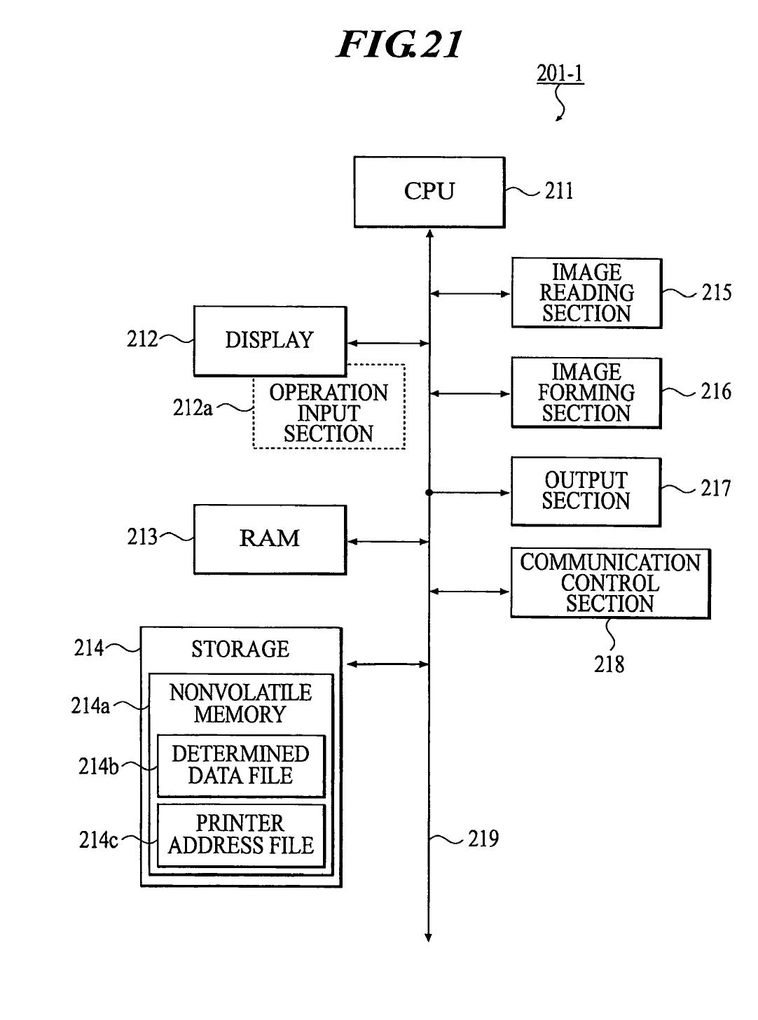

Next, the internal structure of the first printer 201-1 will be explained in detail with reference to FIG. 21. FIG. 21 is a block diagram showing the functional structure of the first printer 201-1. As shown in FIG. 21, like the first printer 201-1 shown in FIG. 8, the first printer 201-1 comprises the CPU 211, the display 212 having the operation input section 212a, the RAM 213, the storage 214, the image reading section 215, the image forming section 216, the output section 217 and the communication control section 218 which are connected to each other through the bus 219.

When reading out the system program for controlling the first printer 201-1 stored in the storage 214 to the RAM 213, the CPU 211 controls the whole first printer 201-1 according to the read system program. Further, when reading out various types of processing programs stored in the storage 214 to the RAM 213, the CPU 211 performs various types of processing according to data inputted through the operation input section 212a or the communication control section 218, stores processing results in the RAM 213, and displays the processing results on the display 212 or makes a paper output unit of the output section 217 output the processing results.

For example, the CPU 211 performs a copying processing for copying documents placed on a contact glass of the image reading section 215, a printing processing for receiving data sent from the second printer 202-1 to 202-N or the data processing apparatus 203, printing and outputting images based on the data, or the like, on the basis of the instruction inputted by the user through operation input section 212a, according to the various types of programs stored in the storage 214.

Further, the CPU 211 performs the following determined data transfer processing according to the program stored in the storage 214. That is, the CPU 211 reads determined data of the instructed determination item out of the determined data file 214b, and sends the determined data with information on necessity for the backup of determined data of the printer selected from the printers stored in the printer address file 214c, to the printer through the network NW, on the basis of the transfer instruction received from the data processing apparatus 203. When sending the determined data or the like to the printer instructed by the data processing apparatus 203, the CPU 211 makes the transfer request to the printer through the network NW, and determines whether the printer is capable of receiving the data or not according as receiving a confirmation response from the printer. Then, when determining that the instructed printer is capable of receiving the data, the CPU 211 transfers the determined data and the information on the necessity of the backup.

Further, when the CPU 211 receives the determined data and the information on the necessity of the backup from any one of the second printers 202-1 to 202-N, and determines that the received information on the necessity of the backup is information that the backup is necessary, the CPU 211 renews the determined data stored in the determined data file 214b of the storage 214.

The display 212, the operation input section 212a, the RAM 213, the image reading section 215, the image forming section 216, the output section 217 and the communication control section 218 have been explained with reference to FIG. 8, and are omitted to be explained herein.

Herein, the image includes not only image data of a figure, a photograph or the like but also text data of characters, signs or the like.

The storage 214 is composed of an EEPROM (Electrically Erasable Programmable Rom) or the like. The storage 214 stores the system program capable of being performed by the first printer 201-1, various types of processing programs capable of being performed according to the system program, data processed according to the processing programs or the like. The program is stored in the program code format readable of the computer. The CPU 211 performs the processing according to the program codes one by one. Further, the storage 214 stores a determined data file 214b for storing various types of determined data of the first printer 201-1 for every determined item, and a printer address file 214c for storing addresses (identification numbers) or the like of apparatuses connected to the network NW including the second printers 202-1 to 202-N.

The internal structure of the first printer 201-1 has been explained. Because the main structure of each of the first printers 201-2 to 201-N and the second printers 202-1 to 202-N is the same as one of the first printer 201-1, it is omitted to show the structure in figures and explain the structure.

Next, the operation will be explained.

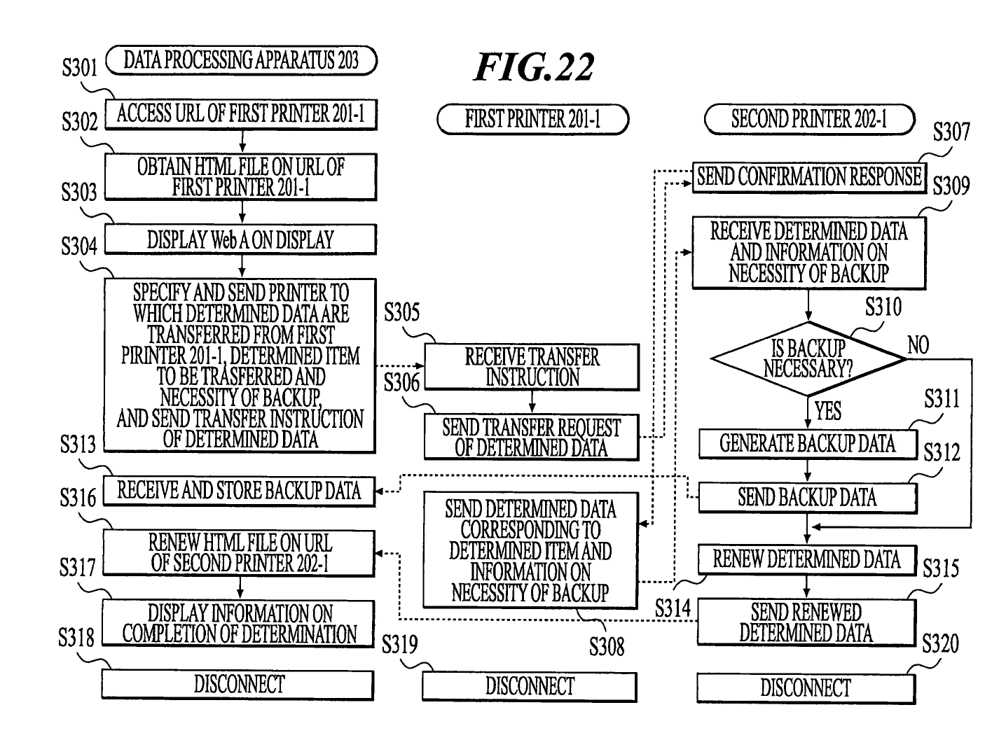

FIG. 22 is a flow chart showing the determined data transfer processing for transferring the determined data of the first printer 201-1 (the origin) to the second printer 202-1 (the other). Herein, the determined data transfer processing will be explained with reference to FIG. 22. According to the embodiment, although it will be explained that the first printer 201-1 is the origin and the second printer 202-1 is the other as one example, the determined data transfer processing can be performed even when the second printer 202-1 is the origin and the first printer 201-1 is the other.

When the data processing apparatus 203 accesses the URL of the first printer 201-1 through the Internet NW according to the operation inputted through the input section 232 (Step S301), the data processing apparatus 203 obtains the HTML file on the URL (Step S302).

When obtaining the HTML file, the data processing apparatus 203 displays the Web screen (Web A) based on the HTML file of the first printer 201-1 on the display 234 (Step S303). When the printer (the second printer 202-1) to which the determined data of the first printer 201-1 are transferred, the determination item of the determined data to be transferred and the necessity of the data-backup of the determination item by the second printer 202-1 are specified on the Web A screen, the data processing apparatus 203 sends the information and the transfer instruction to transfer the determined data to the second printer 202-1, to the first printer 201-1 through the network NW (Step S304).

When receiving the transfer instruction through the communication control section 218 from the data processing apparatus 203 (Step S305), the first printer 201-1 sends the transfer request to the second printer 202-1 through the network NW (Step S306). When receiving the transfer request of the determined data from the first printer 201-1, the second printer 202-1 sends the confirmation response to the first printer 201-1 (Step S307).

When receiving the confirmation response from the second printer 202-1, the first printer 201-1 determines to be able to transfer the determined data to the second printer 202-1. Therefore, the first printer 201-1 reads the determined data corresponding to the determined item transferred and instructed by the data processing apparatus 203 in Step S305 out of the determined data file 214b, and sends the determined data with the information on the necessity of the backup of the data to the address of the second printer 202-1 stored in the printer address file 214c through the network NW (Step S308).

When the first printer 201-1 can not receive the confirmation response from the second printer 202-1, or receive the transfer rejection, the first printer 201-1 determines to be unable to transfer the determined data to the second printer 202-1, and informs the data processing apparatus 203 of the matter. Then, the data processing apparatus 203 displays the matter that the determined data can not be transferred to the second printer 202-1, on the Web A.

When receiving the determined data corresponding to the determined item and the information on the necessity of the backup of the existing determined data through the communication control section 228 from the first printer 201-1 (Step S309), the second printer 202-1 determines the necessity of the backup on the basis of the received information (Step S310). When the backup of the existing determined data is necessary (Step S310; YES), the second printer 202-1 generates the backup data for the existing determined data (Step S311), and sends the backup data to the data processing apparatus 203 (Step S312). When receiving the backup data from the second printer 202-1, the data processing apparatus 203 saves the backup data in the storage 235 (Step S313).

When receiving the information that the backup of the determined data is unnecessary from the first printer 201-1 in Step S309 (Step S310; NO), or sending the backup data to the data processing apparatus 203 in Step S312, the second printer 202-1 performs the processing in Step S314. Then, when renewing the determined data file 214b of the storage 214 on the basis of the determined data received from the first printer 201-1 (Step S314), the second printer 202-1 sends the renewed determined data to the data processing apparatus 203 (Step S315). When receiving the renewed determined data from the second printer 202-1, the data processing apparatus 203 renews the contents of the HTML file on the URL of the second printer 202-1 to the new determined data (Step S316). Then, when the data processing apparatus 203 displays the matter the transfer of the determined data from the first printer 201-1 to the second printer 202-1 is finished on the display 234 (Step S317), the data processing apparatus 203 disconnects the communication, and finishes the processing (Step S318). The first printer 201-1 and the second printer 202-1 disconnect the communication, and finish the processing (Steps S319 and S320).

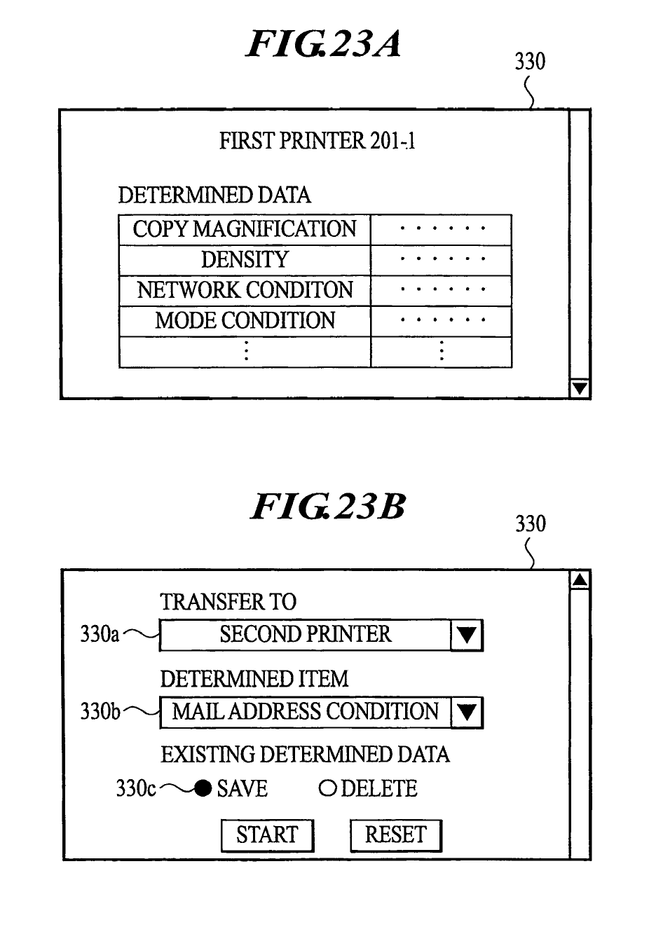

FIGS. 23A and 23B are views showing examples of the Web A screen 330 displayed on the display 234 of the data processing apparatus 203. As shown in FIG. 23A, the determined data of the first printer 201-1 are displayed on the Web A screen 330. The user of the data processing apparatus 203 can recognize the determined data of the first printer 201. Further, the determination screen shown in FIG. 23B is displayed on the Web A screen 330, by scrolling the screen. The determination screen includes a data transferred printer specifying area 330a for specifying the printer to which the determined data are transferred, a determined item specifying area 330b for specifying the determined item of the determined data to be transferred and a backup specifying area 330c for specifying the necessity (if necessary, “save”, but if unnecessary, “delete”) of the backup of the existing determined data of the determined item of the printer to which the determined data are transferred. When the user pushes the arrow button of the data transferred printer specifying area 330a, because the printers to which the determined item can be transferred are displayed as the choices, the user can select any of the printers easily. Further, when the user pushes the arrow button of the determined item specifying area 330b, because the determined items are displayed as the choices, the user can select any of the determined items easily. After specifying the condition in each area, when the “START” button is pushed, the data processing apparatus 203 sends the information to the first printer 201-1, or when the “RESET” button is pushed, the data processing apparatus 203 resets the specified information.

As described above, according to the information sharing system 210, when the printer to which the determined data of the first printer 201-1 are transferred, the determined item to be transferred and the necessity of the backup of the existing data of the printer to which the determined data are transferred are specified on the Web screen displayed on the data processing apparatus 203, the first printer 201-1 receives the instruction through the network NW. Then, the first printer 201-1 transfers the determined data of the specified item stored in the determined data file 214b to the specified second printer 202-1. The second printer 202-1 renews the information of the determined data file on the basis of the transferred determined data. When the backup is necessary, the second printer 202-1 makes the data processing apparatus 203 save the unchanged (existing) determined data through the network NW.

Consequently, because various types of determined data provided for one printer can be provided for another printer by performing the simple remote-operation on the Web screen, it is possible to variously set up the printers effectively. Further, because the determined data provided for one printer can be transferred and provided for another printer, it is possible to prevent the determination miss from occurring. Further, because the past determined data can be save, even if there occurs an error in the determination, it is possible to restore the determination easily. Further, because it is possible to specify whether to save the existing determined data or not when renewing the determined data, it is possible to prevent the unnecessary backup. Further, because the determined data concerning the printer can be recognized on the Web screen corresponding to the printer, it is possible to manage the determined data easily.

The description according to the above-described embodiment is one of preferable examples of the information sharing system 210, and the information sharing system 210 is not limited to the above-described embodiment.

For example, although it has been explained that the transferred determined items are displayed as the choices according to the above-described embodiment, the choice for transferring all the determined items at one time may be displayed together. Consequently, it is possible to transfer the data rapidly in order to share the determined items.

Further, even if the determined data are changed in each printer according to the general method, when each printer sends the changed data to the data processing apparatus 203, and the data processing apparatus 203 renews the contents of the HTML file on the URL of each printer, it is possible to always confirm the determined data of each printer on the Web screen.

Further, because the data processing apparatus 203 saves the backup data, it is possible to prevent the increase in the capacity of the storage 224 of the second printer 202-1 caused by the backup. It is needless to say that the existing determined data may be saved in the storage 214 of the first printer 201-1 which has transferred the data for the case there occurs an error in the determination.

Further, although it has been explained that the present invention is applied to the printer according to the embodiment, the present invention may be applied to an image forming apparatus such as a FAX, a scanner or the like.

The detailed structure and function of the information sharing system 210 or each section thereof are not limited to the embodiment and may be variously changed and modified without departing from the gist of the present invention.

The entire disclosures of Japanese Patent Application Nos. Tokugan 2002-188893, 2002-236847 and 2002-250489 filed on June 28, August 15 and Aug. 29, 2002 including specifications, claims, drawings and summaries are incorporated herein by reference in their entirety.

What is claimed is:

1-11. (canceled)

12. An information sharing system for image forming apparatuses comprising:
a first image forming apparatus comprising:
a first storage for storing first determined data for controlling image formation;
a determined data providing section for performing a processing concerning a predetermined request; and
a first controller for controlling the determined data providing section; and
a second image forming apparatus comprising:
a second storage for storing second determined data for controlling image formation;
a determined data obtaining section for making the predetermined request; and
a second controller for controlling the determined data providing section.

13. The system of claim 12, wherein the determined data obtaining section sends determined data request data for requesting the first determined data to the determined data providing section, and
the determined data providing section provides the first determined data requested based on the determined data request data.

14. The system of claim 12, wherein the first controller reads the first determined data stored in the first storage, and makes the determined data providing section send the first determined data to the second image forming apparatus, and
the second controller stores the first determined data received by the determined data obtaining section from the first image forming apparatus in the second storage.

15. The system of claim 12, further comprising a plurality of first image forming apparatuses and a plurality of second image forming apparatuses,
wherein the determined data obtaining section of any one of the plurality of second image forming apparatuses sends the determined data request data for requesting the first determined data of any one of the plurality of first image forming apparatuses, to the any one of the plurality of first image forming apparatuses, and
the first controller of the first image forming apparatus which receives the determined data request data reads the first determined data requested based on the determined data request data out of the first storage, and makes the determined data providing section send the first determined data to the second image forming apparatus.

16. The system of claim 13, wherein each of the first determined data, the second determined data and the determined data request data include item identification data for identifying a determined item.

17. The system of claim 16, wherein the second storage comprises a storage area corresponding to the item identification data, and
the second controller stores the first determined data received from the first image forming apparatus in the second storage when determining that the second storage comprises a storage area corresponding to the item identification data included in the first determined data received from the first image forming apparatus.

18. The system of claim 17, wherein the second controller stores the item identification data and a data storage capacity threshold related to the item identification data in the second storage, and stores the first determined data received from the first image forming apparatus in the second storage when determining that data amount of the first determined data received from the first image forming apparatus is not more than the data storage capacity threshold corresponding to the item identification data included in the first determined data.

19. The system of claim 12, wherein the first image forming apparatus further comprises a second determined data obtaining section for making a predetermined request,
the second image forming apparatus further comprises a second determined data providing section for performing a processing concerning the predetermined request,
the first controller controls the second determined data obtaining section to request the second determined data providing section to output the second determined data, and
the second controller controls the second determined data providing section to provide the second determined data to the second determined data obtaining section.

20. The system of claim 19, wherein each of the first determined data and the second determined data include item identification data for identifying a determined item.

21. The system of claim 20, wherein the first storage comprises a storage area corresponding to the item identification data, and the first controller stores the second determined data received from the second image forming apparatus in the first storage when determining that the first storage comprises a storage area corresponding to the item identification data included in the second determined data received from the second image forming apparatus.

22. The system of claim 21, wherein the first controller stores the item identification data and a data storage capacity threshold related to the item identification data in the first storage, and stores the second determined data received from the second image forming apparatus in the first storage when determining that data amount of the second determined data received the second image forming apparatus is not more than the data storage capacity threshold corresponding to the item identification data included in the second determined data.

23. The system of claim 12, further comprising a data processing apparatus comprising an instruction sending section for sending a determined data providing instruction to at least the first controller,
wherein the first image forming apparatus further comprises an instruction receiving section for receiving the determined data providing instruction sent from the instruction sending section, and
the first controller provides the first determined data to the second image forming apparatus on the basis of the determined data providing instruction received by the instruction receiving section.

24. The system of claim 23, wherein the data processing apparatus further comprises an input receiving section for receiving an input of a determined data providing apparatus capable of receiving the determined data providing instruction,
wherein the instruction sending section sends the determined data providing instruction to the determined data providing apparatus received by the input receiving section.

25. The system of claim 23, wherein the first image forming apparatus further comprises a determination section for determining the first determined data,
the first storage stores the first determined data determined by the determination section, and a determined data transfer address to which the first determined data are transferred, and
the determined data providing section provides the first determined data stored in the first storage to the determined data transfer address, on the basis of the determined data providing instruction received by the instruction receiving section.

26. The system of claim 25, wherein the first controller determines whether the second image forming apparatus having the determined data transfer address to which the first determined data are transferred is capable of receiving data or not, and
the determined data providing section provide the first determined data to the second image forming apparatus when the first controller determines that the second image forming apparatus is capable of receiving data.

27. The system of claim 26, wherein the first controller communicates with the second image forming apparatus, and determines whether the second image forming apparatus is capable of receiving data or not on the basis of a communication result.

28. The system of claim 23, wherein the first controller selects determined data instructed to be provided from the first determined data stored in the first storage on the basis of the determined data providing instruction received by the instruction receiving section, and
the determined data providing section provides the determined data selected by the first controller to the second image forming apparatus.

29. The system of claim 23, wherein the first storage stores a plurality of determined data transfer addresses to which the first determined data are transferred,
the first controller selects any one of the plurality of determined data transfer addresses stored in the first storage on the basis of the determined data providing instruction received by the instruction receiving section, and
the determined data providing section provides the first determined data to the determined data transfer address selected.

30. The system of claim 23, wherein the second image forming apparatus further comprises a determined data renewing section for renewing the second determined data stored in the second storage based on the first determined data received by the determined data obtaining section from the first image forming apparatus.

31. The system of claim 30, wherein the second image forming apparatus further comprises a save section for saving the second determined data stored in the second storage when renewing the second determined data stored in the second storage based on the first determined data received by the determined data obtaining section from the first image forming apparatus.

32. The system of claim 31, wherein the determined data providing section sends data for instructing whether to save the second determined data stored in the second storage in the save section of the second image forming apparatus or not, when providing the first determined data stored in the first storage to the second image forming apparatus on the basis of the determined data providing instruction received by the instruction receiving section.

33. The system of claim 23, further comprising a plurality of first image forming apparatuses comprising determination sections for determining the first determined data, and a plurality of second image forming apparatuses,
wherein the data processing apparatus further comprises a specifying section for specifying any first image forming apparatus of the plurality of first image forming apparatuses to provide the first determined data, an item of the first determined data of the first image forming apparatus to be provided, and any second image forming apparatus of the plurality of second image forming apparatuses to which the first determined data corresponding to the item are provided,
the instruction sending section sends the determined data providing instruction and information specified by the specifying section to the first controller of the first image forming apparatus specified by the specifying section,
the first storage stores the first determined data determined by the determination section, and a determined data transfer address to which the first determined data are transferred,
the determined data providing section provides the first determined data stored in the first storage to the determined data transfer address on the basis of the determined data providing instruction received by the instruction receiving section, and
the second image forming apparatus further comprises a determined data renewing section for renewing the second determined data stored in the second storage based on the first determined data received by the determined data obtaining section from the first image forming apparatus.

34. The system of claim 33, wherein the second image forming apparatus further comprises a save section for saving the second determined data stored in the second storage when receiving the first determined data from the first image forming apparatus.

35. The system of claim 23, wherein the second image forming apparatus an existing data sending section for sending the second determined data store in the second storage to the data processing apparatus when receiving the first determined data from the first image forming apparatus, and
the data processing apparatus further comprises a save section for saving the second determined data received from the second image forming apparatus.

36. The system of claim 33, wherein the specifying section of the data processing apparatus specifies whether to save the second determined data stored in the second storage of the second image forming apparatus to which the first determined data are provided or not,
the instruction sending section of the data processing apparatus sends the determined data providing instruction and information specified by the specifying section to the first image forming apparatus specified by the specifying section,
the instruction receiving section of the first image forming apparatus receives the determined data providing instruction from the data processing apparatus, and
the determined data providing section of the first image forming apparatus sends data for instructing whether to save the second determined data stored in the second storage of the second image forming apparatus or not when providing the first determined data stored in the first storage to the second image forming apparatus on the basis of the determined data providing instruction received by the instruction receiving section.

37. The system of claim 33, wherein the first image forming apparatus further comprises a second determined data obtaining section for making a predetermined request,
the second image forming apparatus further comprises a second determined data providing section for performing a processing concerning the predetermined request,
the instruction sending section of the data processing apparatus sends the determined data providing instruction to the second controller,
the second image forming apparatus further comprises a second instruction receiving section for receiving the determined data providing instruction sent from the instruction sending section, and
the second controller provides the second determined data to the first image forming apparatus on the basis of the determined data providing instruction received by the second instruction receiving section.

38. The system of claim 37, wherein the second image forming apparatus further comprises a second determination section for determining the second determined data,
the second storage stores the second determined data determined by the second determination section, and a determined data transfer address to which the second determined data are transferred, and
the second determined data providing section provides the second determined data stored in the second storage to the determined data transfer address on the basis of the determined data providing instruction received by the second instruction receiving section.

39. The system of claim 38, wherein the second controller determines whether the first image forming apparatus to which the second determined data are transferred is capable of receiving data or not, and
the second determined data providing section provides the second determined data to the first image forming apparatus when the second controller determines that the first image forming apparatus is capable of receiving data.

40. The system of claim 39, wherein the second controller communicates with the first image forming apparatus, and determines whether the first image apparatus is capable of receiving data or not on the basis of a communication result.
